(19) United States
(12) Patent Application Publication
(10) Pub. No.: US 2014/0368977 A1
(43) Pub. Date: Dec. 18, 2014

(54) Modular Device System for Electrical Wiring

(71) Applicant: Grissom Lenny, St. Petersburg, FL (US)

(72) Inventor: Grissom Lenny, St. Petersburg, FL (US)

(21) Appl. No.: 13/916,541

(22) Filed: Jun. 12, 2013

(51) Int. Cl. H02J 3/00

(52) U.S. Cl. CPC H02J 3/005
USPC 361/627; 439/491

(57) ABSTRACT

A color-coded modular system for outlets, switches and light outlets includes a device, box and module for residential structures: an outlet with female receptacle on the front and a male plug on the back; a switch with a switch on the front and a male plug on the back. The device has attachment ridges on side walls connectable with the box having an open front and back, and attachment ridges on the front inside walls connectable with a device, and attachment ridges on the back outside walls connectable to the module. The module's recessed face has a female receptacle connectable with the male device plugs and an insertion hole to accept wires. For commercial structures, knock outs on the module receive conduit with wires for insertion holes. A retrofit box module is one piece installed inside an existing box, existing wires inserted in the module back in insertion holes.

This application is a Continuation-In-Part of and claims priority to U.S. patent application Ser. No. 13/114,373, filed on May 24, 2011.

### BACKGROUND

The present invention relates to the field of residential and commercial electrical wiring, in particular, electrical wiring of electrical devices such as outlets, light outlets, switches, ceiling fan outlets, a chime and push button, a smoke detector and a thermostat.

Light outlets, outlets, switches, ceiling fans, smoke detectors, chimes and push button, thermostats and the like require a power source to function. In conventional electrical wiring systems, four wires are used, a neutral wire with white covering, a hot wire with black covering, a second hot wire generally with a red covering, and a ground wire either a bare wire or with a green covering. To take an example, U.S. Pat. No. 5,266,039 to Boyer depicts a typical outlet receptacle (FIG. 1). Two screws on each side of the outlet receptacle receive a white wire and black wire, respectively. A third screw (not shown) receives a ground wire.

All these wires are inserted in a box along with the device and typically enclosed by a cover plate. An example of this can be seen in U.S. Pat. No. 6,191,361 to Matty, which depicts an outlet receptacle connected to three wires (black, white, ground) and inserted into a box.

Another example is a lighting fixture such as in U.S. Pat. No. 4,590,544 to Decandia which depicts a lighting fixture with two wires (black and white) that are connected by wire nuts to two other wires (black and white) protruding from a wire insertion hole. These wires are all inserted into a box in a wall or ceiling.

The problem with the conventional system for wiring device in a wall or in a ceiling is the danger posed by numerous wires crammed into a box or crammed onto a electrical device, as well as the risk of miss-wiring device. Moreover, live electrical wiring and screws are exposed inside the box, and wires are twisted together with wire nuts, that can come loose. Most electrical distribution fires result from problems with “fixed wiring” such as faulty electrical outlets and old wiring. As a result, over 1,000 people are electrocuted annually due to faulty or defective electrical wiring and electrical devices, or by coming in contact with wires or device screws, according to the United States Consumer Product Safety Commission.

Light fixtures and lamps are also leading causes of electrical fires.

Many avoidable electrical tires can be traced to misuse of electric cords, such as overloading circuits, poor maintenance, and running the cords under rugs or in high traffic areas without the protection of an ARC fault interrupter circuit.

The U.S. Consumer Product Safety Commission suggests that strategies for eliminating childhood electrocution should concentrate on ensuring safe domestic environments with properly maintained devices.

The National Electrical Code seeks to prevent electrical shock with various mandates.

Among them, are to prevent the over-filling of a box and electrical receptacle devices, properly matching 14 gauge wires to 15 amp circuits and 12 gauge wires to 20 amp circuits, avoiding improper wiring of switches, and safeguarding against the installation of electrical device upside down.

Thus, the objective of the present invention is to create a new electrical wiring system for electrical devices installed in box and inserted in walls and ceilings, both for residential and commercial structures, that comprise device 100, box 200 and module 300 that are completely sealed, that avoid the overloading of circuits, overfilling of box 200 and device 100, and that eliminates excessive wires stuffed in a box 200 and crammed on a electrical device 100, eliminates any exposed wires or conductive material and reduces the risk of improper installation.

The objective is achieved in the case of residential structures by way of a wiring system comprised of a device 100, a box 200 with two open sides, and a module 300, wherein the back side of the device 100 comprises at least one male plug and the front side of the module 300 comprises at least one female hole, wherein the at least one male plug inserts into the at least one female outlet receptacle through the open sides of the box 200 when the device 100, box 200, and module 300 are joined together, wherein the back side of the module 300 comprises multiple wire insertion holes, and wherein at least one female hole is continuous with at least one wire insertion hole. A key feature of the modular device system is the elimination of manual wire make-up. Wire make-up is the joining of multiple wires in a specific manner to perform one of the many different wiring functions or adding of a secondary wire to perform a specific wiring function. This modular device system has built-in hard wire make-up in the devices and or modules to eliminate the need for manual make-up. Built-in make-up eliminates overfill of a box and of a device. Built-in make-up eliminates the need to twist wires together and screw on a wire nut that may lose thus exposing wires that can cause a fire. It also hides all wiring inside the sealed devices and modules which prevents electrocution. With built-in make-up installation is very simple and quick.

In the case of commercial structures, the objective is achieved by way of a wiring system a device 100, a box 200 with two open sides, and a module 300, wherein the back side of the device 100 comprises at least one male plug that inserts into the front side of the module 300 comprising at least one female outlet receptacle, wherein the module 300 comprises a holes to accept the conduit through which wires may enter and exit, wherein the hole to accept the conduit in the module 300 comprises multiple wire insertion holes, and wherein at least one female outlet receptacle of the module 300 is continuous with at least one wire insertion hole of the module 300.

### SUMMARY

The present invention is a modular device system for electrical wiring with a device 100 such as outlets, switches, light outlets, ceiling fans outlets, smoke detectors, thermostats, chimes and push buttons. Other devices include construction devices to be used during the construction phase of a building, down-line device which is devices that are connected to an up-line device that is either protected with a Ground Fault Circuit Interrupter or are fault interrupter circuit. Other invented devices such as ground fault interrupter circuit, are fault interrupter circuit, an USB device and an eight pin device may be used. In the case of residential structures, the wiring system is comprised of a device 100, a box 200 with two open sides, and a module 300, wherein the back side of the device 100 comprises at least one male plug and the front side of the module 300 comprises at least one female outlet receptacle, wherein the at least one male plug inserts into the at least one female outlet receptacle through the open sides of the box 200 when the device 100 is joined with the module 300 through one side of the box 200 and the module 300 is joined to device 100 through the other side of the box 200, wherein the back, top, or bottom side of the module 300 comprises at least one section comprising at least two wire insertion holes, and wherein at least one female outlet receptacle is continuous with at least one wire insertion hole. To avoid improper installation, the invention utilizes a color coding system as well as indicia to indicate proper positioning. Another key feature of the modular device system is the elimination of manual wire make-up. Wire make-up is the joining of multiple wires in a specific manner to perform one of the many different wiring functions or adding of a secondary wire to perform a specific wiring function. This modular device system has built-in hard wire make-up in the devices and or modules to eliminate the need for manual make-up. Built-in make-up eliminates overfill of a box and of a device. Built-in make-up eliminates the need to twist wires together and screw on a wire nut that may lose thus exposing wires that can cause a fire. It also hides all wiring inside the sealed devices and modules which prevents electrocution. With built-in make-up installation is very simple and quick.

For commercial structures, the module 300 comprises knock-out holes for wires to enter through conduits.

### BRIEF DESCRIPTION OF THE FIGURES

FIG. 1 depicts a perspective view of a device 100, a box 200, and a module 300.

FIG. 2 depicts a side view of a device 100, a box 200, and a module 300.

FIG. 3 depicts a side view of a device 100, a box 200, and a module 300 joined together placed in a wall.

FIG. 4 depicts a front view of a ground fault circuit interrupter outlet device 100.

FIG. 5 depicts a rear view of a ground fault circuit interrupter outlet device 100.

FIG. 6 depicts a front view of a ground fault circuit interrupter construction outlet device 100.

FIG. 7 depicts a rear view of a ground fault circuit interrupter construction outlet device 100.

FIG. 8 depicts a front view of a down-line outlet device 100.

FIG. 9 depicts a rear view of a down-line outlet device 100.

FIG. 10 depicts an inside view of an internal ground fault circuit interrupter components in a ground fault circuit interrupter outlet device 100.

FIG. 11 depicts an inside view of an internal make-up circuitry of a ground fault circuit interrupter outlet device 100.

FIG. 12 depicts a recessed front face of a ground fault circuit interrupter outlet module 300.

FIG. 13 depicts a rear face of a ground fault circuit interrupter outlet module 300.

FIG. 14 depicts a inside view of a wire insertion hole make-up of a ground fault circuit interrupter circuit outlet module 300.

FIG. 15 depicts an inside view of a cross section of wire insertion holes of a ground fault circuit interrupter outlet module 300.

FIG. 16 is a front view of an arc fault circuit interrupter construction outlet device 100.

FIG. 17 is a rear view of an arc fault circuit interrupter outlet device 100.

FIG. 18 is a front view of an arc fault circuit interrupter construction outlet device 100.

FIG. 19 is a rear view of an arc fault circuit interrupter construction outlet device 100.

FIG. 20 is a front view of a down-line outlet device 100.

FIG. 21 is a rear view of a down-line outlet device 100.

FIG. 22 depicts a inside view of an internal arc fault circuit interrupter components of an arc fault circuit interrupter outlet device 100.

FIG. 23 depicts an inside view of an internal make-up of an arc fault circuit interrupter outlet device 100.

FIG. 24 depicts a front face of a ground fault circuit interrupter switch device 100.

FIG. 25 depicts a front face of an arc fault circuit interrupter switch device 100.

FIG. 26 depicts an inside make-up, in this case, of a ground fault circuit interrupter switch device 100.

FIG. 27 depicts a rear face, in this case, of a ground fault circuit interrupter switch device 100.

FIG. 28 depicts a recessed front face of, in this case, of a ground fault circuit interrupter switch module 300.

FIG. 29 depicts a rear face of, in this case, of a ground fault circuit interrupter switch module 300.

FIG. 30 depicts a inside view of a internal wire insertion hole make-up of a ground fault circuit interrupter switch module 300.

FIG. 31 depicts a cross section of wire insertion holes of a ground fault circuit interrupter switch module 300.

FIG. 32 depicts a front face of, in this case, a three gang Ground Fault Circuit Interrupter switch device 100.

FIG. 33 depicts a front face of, in this case, a three gang arc fault interrupter circuit switch device 100.

FIG. 34 depicts an inside make-up, in this case, of a Ground Fault Circuit Interrupter switch device 100.

FIG. 35 depicts a rear face, in this case, of a Ground Fault Circuit Interrupter switch device 100.

FIG. 36 depicts a recessed front face of, in this case, of a Ground Fault Circuit Interrupter switch module 300.

FIG. 37 depicts a rear face of, in this case, of a Ground Fault Circuit Interrupter switch module 300.

FIG. 38 depicts a wire insertion hole make-up of a ground fault circuit interrupter circuit electrical switch module 300.

FIG. 39 depicts a cross section of wire insertion holes of a ground fault circuit interrupter electrical switch module 300.

FIG. 40 depicts a front view of a speaker outlet device 100.

FIG. 41 depicts a rear view of a speaker outlet device 100.

FIG. 42 depicts a front view of a speaker outlet module 300.

FIG. 43 depicts a rear view of a speaker outlet module 300.

FIG. 44 depicts a front view of a retrofit box 200.

FIG. 45 depicts a side view of a retrofit box 200.

FIG. 46 depicts a side view of a retrofit device 100, a box 200 and a module 300 joined together inside an existing present day electrical box 200.

FIG. 47 depicts a front view of a dryer outlet device 100.

FIG. 48 depicts a rear view of a dryer outlet device 100.

FIG. 49 depicts a side view of a dryer outlet box 200.

FIG. 50 depicts a front view of a dryer outlet module 300.

FIG. 51 depicts a top view of a dryer outlet module 300.

FIG. 52 depicts a front view of a range outlet device 100.

FIG. 53 depicts a rear view of a range outlet device 100.

FIG. 54 depicts a side view of a range outlet box 200.

FIG. 55 depicts a front view of a range outlet module 300.

FIG. 56 depicts a top view of a range outlet module 300.

FIG. 57 depicts a front view of a thermostat outlet device 100.

FIG. 58 depicts a rear view of a thermostat outlet device 100.

FIG. 59 depicts a side view of a thermostat outlet box 200.

FIG. 60 depicts a front view of a thermostat outlet module 300.

FIG. 61 depicts a top view of a thermostat outlet module 300.

FIG. 62 depicts a front view of a chime outlet device 100.

FIG. 63 depicts a rear view of a chime outlet device 100.

FIG. 64 depicts a side view of a chime outlet box 200.

FIG. 65 depicts a front view of a chime outlet module 300.

FIG. 66 depicts a top view of a chime outlet module 300.

FIG. 67 depicts a front view of a push button outlet device 100.

FIG. 68 depicts a rear view of a push button outlet device 100.

FIG. 69 depicts a side view of a push button outlet box 200.

FIG. 70 depicts a front view of a push button outlet module 300.

FIG. 71 depicts a top view of a push button outlet module 300.

FIG. 72 depicts a front view of a smoke detector outlet device 100.

FIG. 73 depicts a rear view of a smoke detector outlet device 100.

FIG. 74 depicts a side view of a smoke detector outlet box 200.

FIG. 75 depicts a front view of a smoke detector outlet module 300.

FIG. 76 depicts a top view of a smoke detector outlet module 300.

FIG. 77 depicts a top view of a light outlet box 200/module 300 combo.

FIG. 78 depicts a rear view of a light outlet module 300.

FIG. 79 depicts a front view of a light fixture connection plate.

FIG. 80 depicts a front view of, in this case, a ground fault circuit interrupter circuit commercial outlet device 100.

FIG. 81 depicts a rear view of, in this case, a ground fault circuit interrupter commercial outlet device 100.

FIG. 82 depicts a side view of a commercial device 100, box 200 and module 300 joined together.

FIG. 83 depicts a top view of a commercial device 100, box 200 and module 300 joined together.

FIG. 84 depicts a rear view of, in this case, a ground fault circuit interrupter commercial outlet module 300.

FIG. 85 depicts a rear view of, in this case, a Ground Fault Circuit Interrupter commercial outlet and light module 300.

FIG. 86 depicts a rear view of, in this case, a Ground Fault Circuit Interrupter commercial outlet and dual light module 300.

### DESCRIPTION

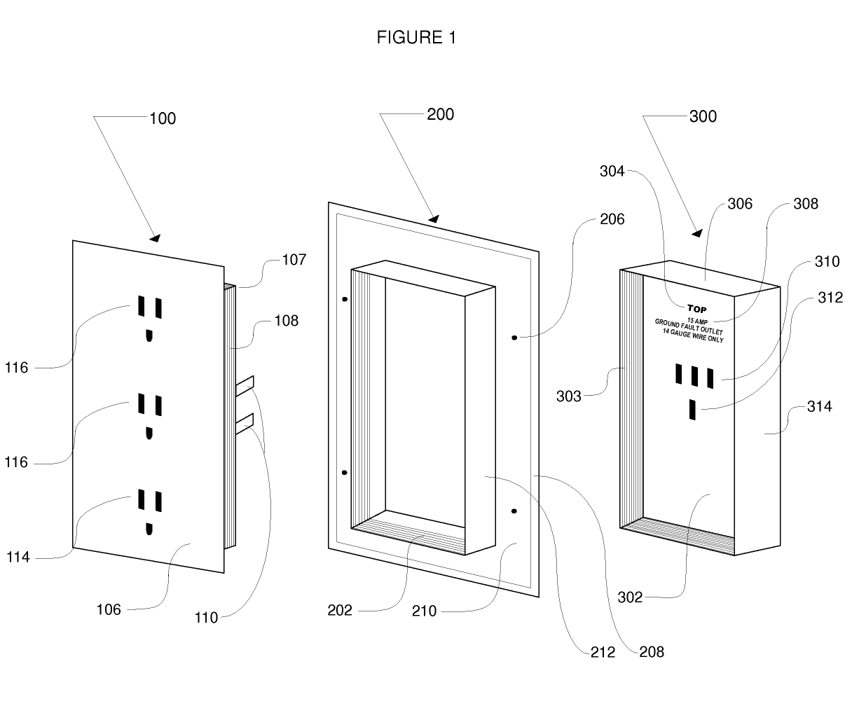

FIG. 1 illustrates a basic design of the invention, comprising a device 100, a box 200 with two open sides comprising a screw-flange 208, and a module 300. A device 100 can be, for example, an outlet, a switch, a smoke detector, a thermostat, a chime, a push button, a light and fan adaptor plate device, etc. Each of the above device types may only mate with a module designed for that specific device 100. The device 100 and module 300 may be color coded so as to make it easier to mate the two correctly and for easier visual inspection of the device and module. The device 100 is designed for residential and commercial structures and comprises on the front of the device at least one female receptacle 111 and one female receptacle 114 and on the rear of the device at least one male plug 110. A box 200 designed for residential and commercial structures comprises two open sides with a screw-flange 208 centered around the box. The retrofit box is a combination of a box and a module as one part with a screw-flange 208 around the front face of the box/module combo. A box 200 comprises side walls 212 with attachment ridges on the inside to snap together with a device 100 which may also have attachment ridges 108. A module 300 preferably comprises “top” indicia 304 indicating the top of a module 300 and “type” indicia 310 to indicate a type of module 300 thereby ensuring proper mating with its matching device 100.

Still referring to FIG. 1, in one exemplary embodiment, the width of the box 200 is 1½ inches and the module 300 is 1¾ inches, with approximately 1¼ inches of the device 100 being inserted into a box 200. Preferably, the height of the device 100 is preferably 2¼ inches, a box 200 is preferably 2¾ inches high, and a module 300 is 2¾ inches high. One side of a screw-flange 208 includes a thin layer of foam 210 designed to make contact a back side of the drywall 400 (not shown) to seal a box 200 to the drywall 400 to eliminate air flow. Screw-flange 208 may have a pair of ⅛ inch holes 206 for screws to be used to attach the box 200 to a framing member 401 (not shown).

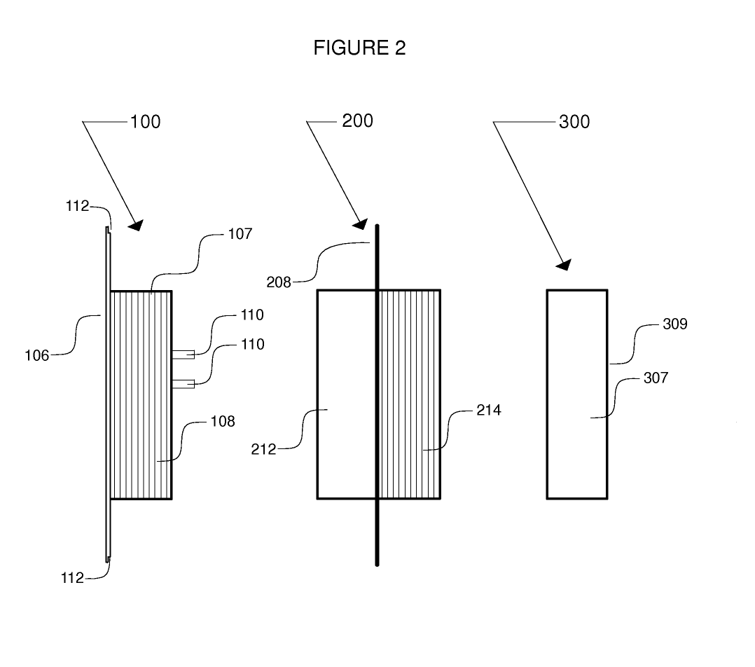

FIG. 2, illustrates a side view of a device 100, a box 200, and a module 300. A side view of a device 100 is shown with a face plate 106 permanently attached to a device 100 as a front of a device 100. The device 100 side walls 107 may have attachment ridges 108 that snap inside a box 200 which may also have attachment ridges 212 (not shown). An optional notches 112 are located at the top and bottom of a face plate 106 for the purpose of inserting a screwdriver (not shown) into the notch 112 for ease of removing a device 100. The device 100 may have one or more electrical male plugs 110 on the back of the device 100. Attachment ridges 214 on the back of a box 200 are for attaching the module 300 with attachment ridges 303 (not shown) to a box 200.

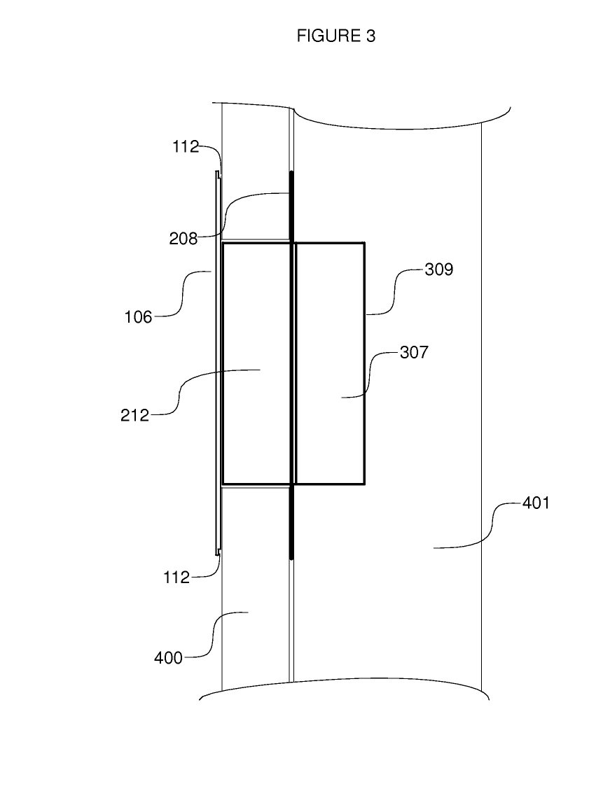

FIG. 3, illustrates a side view of a device 100, a box 200, and a module 300 that are shown joined together with a device 100 inserted into a box 200 and a module 300 inserted over a box 200. Side walls 212 are positioned at the front of the framing member so that the front edge of box 200 is flush with the front face of drywall 400. Box 200 is attached to a framing member 401 behind drywall 400 with a screw-flange 208 (not shown) to a framing member 400. An optional notch 112 is located at the top and bottom of a face plate 106 for the purpose of inserting a screwdriver (not shown) into the notch for ease of removing a device 100. The combined width of a device 100, box 200, and module 300 inside the drywall 400 is preferably 2¼ inches.

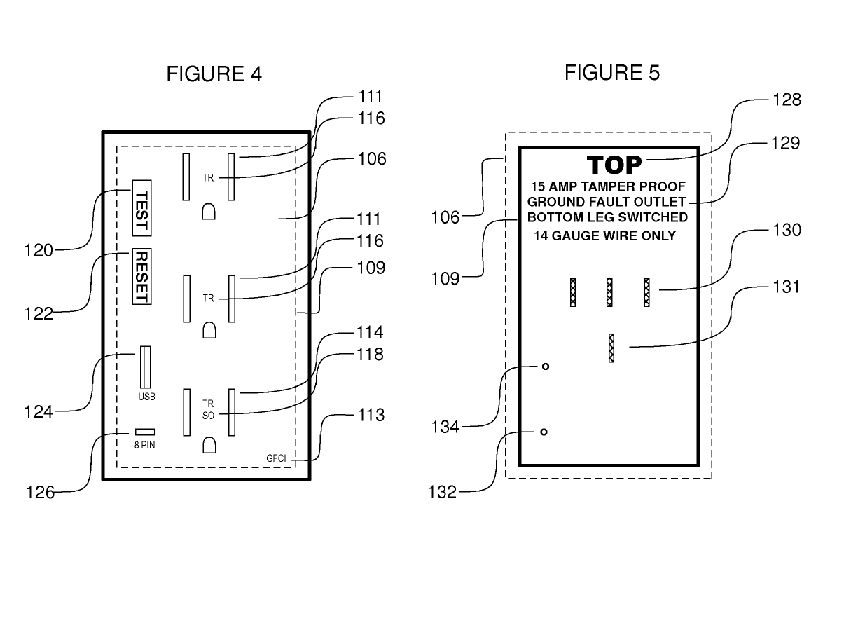

FIG. 4, illustrates a front face of a Ground Fault Circuit Interrupter (GFCI) device 100 with an optional media device comprises a Ground Fault Circuit Interrupter (GFCI) Test button 120 and Reset button 122. The device 100 comprises at least one female receptacle 111 and at least one female receptacle 114. The device 100 may comprise indicia “TR” 116 indicating that the outlet leg female receptacles are Tamper Proof and the bottom leg female receptacles may comprise indicia “SO” 118 indicating that the bottom leg has built-in make-up to make it a switched outlet. A face plate 106 may comprise indicia describing the type of protection, in this case “GFCI” Ground Fault Circuit Interrupter (GFCI)” describing the type of protection, in this case indicating that a device 100 is Ground Fault Circuit Interrupter (GFCI) protected. An optional media device 100 comprises an USB device 124 and an eight pin device 126. Dashed lines 109 depict the side walls 107 of a device 100 behind a face plate 106.

FIG. 5, illustrates a rear face of a Ground Fault Circuit Interrupter (GFCI) device 100 comprises “top” indicia 128 indicating the top of a device 100 and “for example: 15 Amp Tamper Proof Ground Fault Outlet Bottom Leg Switched 14 Gauge Wire Only” indicia 129 indicating the type of device 100. A device 100 comprises at least one male plug 130 to supply electrical current to the device to each of the device's legs and one male plug 131 to switch electrical power to the bottom leg on or off. A device 100 comprises a male USB plug 134 to supply electrical power to the USB device 124 and comprises a male eight pin plug 132 to supply power to the eight pin device 126.

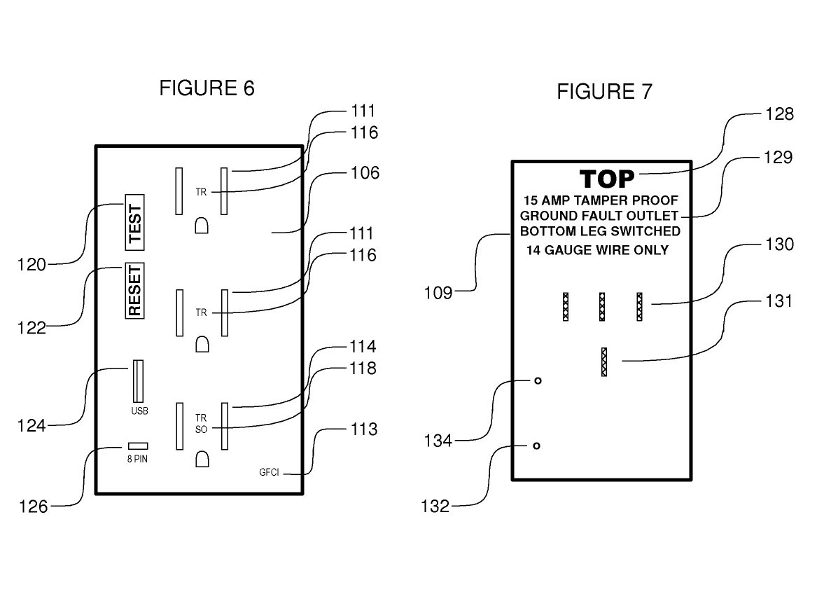

FIG. 6 illustrates a front face of a Ground Fault Circuit Interrupter (GFCI) construction device 100 with an optional media device comprises a Ground Fault Circuit Interrupter (GFCI) Test button 120 and Reset button 122. The construction device 100 comprises at least one female receptacle 111 and at least one female receptacle 114. The construction device 100 may comprise indicia “TR” 116 indicating that the outlet legs are Tamper Proof and the bottom leg may comprise indicia “SO” 118 indicating that the bottom leg has built-in make-up to make it a switched outlet. A face plate 106 may comprise indicia “(GFCI)” 113 describing the type of protection, in this case describing the type of protection, in this case, indicating that the construction device 100 is Ground Fault Circuit Interrupter (GFCI) protected. An optional media device 100 comprises an USB device 124 and an eight pin device 126.

FIG. 7 illustrates the rear face of a Ground Fault Circuit Interrupter (GFCI) construction device 100 comprises “top” indicia 128 indicating the top of an construction device 100 and “for example: 15 Amp Tamper Proof Ground Fault Outlet Bottom Leg Switched 14 Gauge Wire Only” indicia 129 indicating the type of device 100. A device 100 comprises at least one male plug 130 to supply electrical current to the device to each of the device's legs and one male plug 131 to switch electrical power to the bottom leg on or off. A device 100 comprises a male USB plug 134 to supply electrical power to the USB device 124 and comprises a male eight pin plug 132 to supply power to the eight pin device 126.

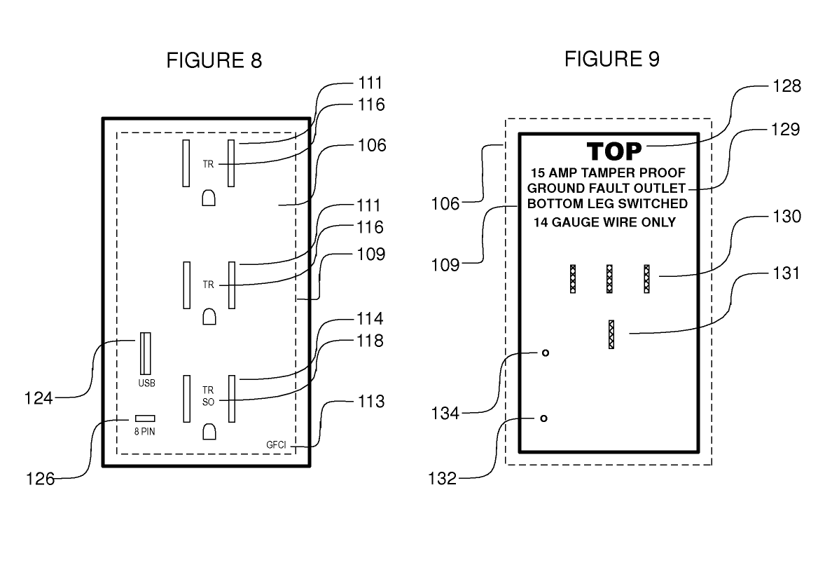

FIG. 8, illustrates the front face of a Ground Fault Circuit Interrupter Ground Fault Circuit Interrupter (GFCI) down-line device 100 with an optional media device 100. A down-line device 100 does not have a Ground Fault Circuit Interrupter (GFCI) device 100 but is has Ground Fault Circuit Interrupter (GFCI) protection from an up-line Ground Fault Circuit Interrupter (GFCI) outlet. A down-line device 100 comprises at least one female receptacle 111 and at least one female receptacle 114. A down-line device 100 comprises indicia TR 116 indicating that the outlet legs are Tamper Proof. The bottom leg comprises indicia “SO” 118 indicating that the bottom leg has built-in make-up to make it a switched outlet. A face plate 106 comprises indicia Ground Fault Circuit Interrupter (GFCI) 113 describing the type of protection, in this case indicating that a device 100 is Ground Fault Circuit Interrupter (GFCI) protected. An optional media device 100 comprises an USB device 124 and an eight pin device 126. Dashed lines 109 depict the side walls 107 of a device 100 behind a face plate 106.

FIG. 9 illustrates the rear face of a Ground Fault Circuit Interrupter (GFCI) down-line device 100 comprises “top” indicia 128 indicating the top of an down-line device 100 and “for example: 15 Amp Tamper Proof Ground Fault Outlet Bottom Leg Switched 14 Gauge Wire Only” indicia 129 indicating the type of device 100. A down-line device 100 comprises at least one male plug 130 to supply electrical current to the device to each of the device's legs and one male plug 131 to switch electrical power to the bottom leg on or off. A device 100 comprises a male USB plug 134 to supply electrical power to the USB device 124 and comprises a male eight pin plug 132 to supply power to the eight pin device 126.

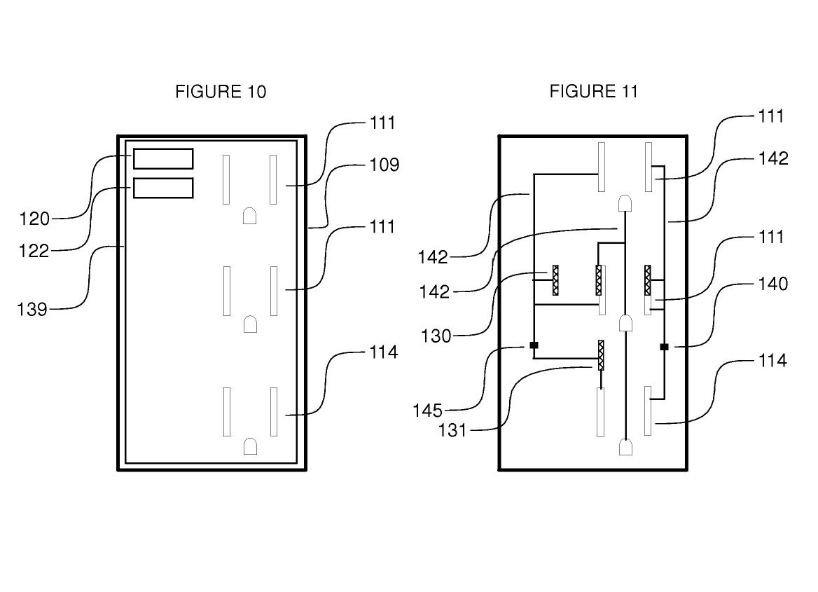

FIG. 10 illustrates the inside of the front face of a Ground Fault Circuit Interrupter (GFCI) device 100. Female receptacle 111 and female receptacle 114 continue from the face plate 106 for connection to conductive strips. A Ground Fault Circuit Interrupter (GFCI) device 139 is embedded inside a device 100. A Ground Fault Circuit Interrupter (GFCI) test device 120 and Ground Fault Circuit Interrupter (GFCI) reset device 122 are embedded inside an electric device 100.

FIG. 11 illustrates the inside of the front face of a Ground Fault Circuit Interrupter (GFCI) device 100 with hard-wire make-up. Female receptacle 111 and female receptacle 114 are connected to conductive strips. A conductive strip 142 connects the hot leg of the female receptacles to the GFCI contact 145. A conductive strip 142 connects the neutral leg of the female receptacles to the GFCI contact 140. A conductive strip 142 connects the ground leg of the female receptacles to other ground legs. Male plug 131 is for switching on or off the electrical power to bottom leg of a device 100.

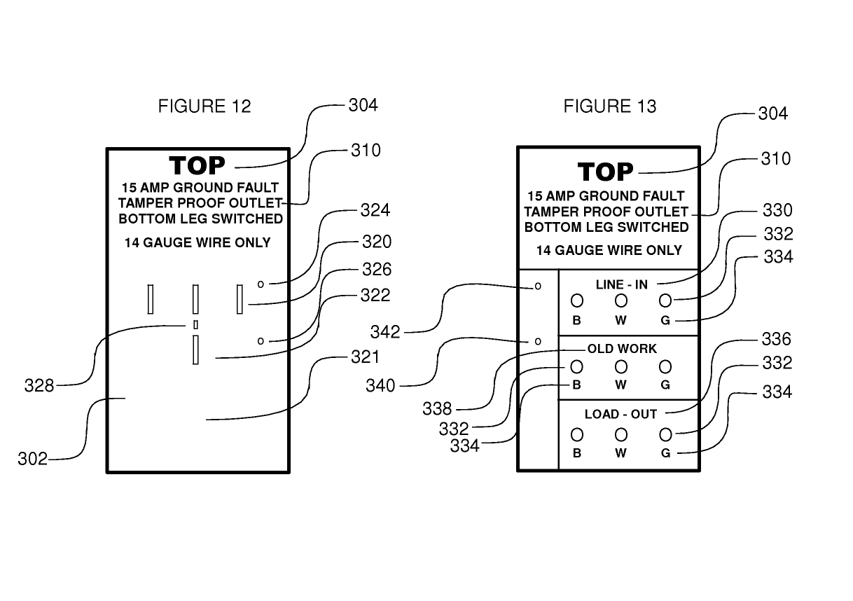

FIG. 12 illustrates the front face of a module 300 comprises “top” indicia 304 indicating the top of a down-line device 100 and “for example: 15 Amp Tamper Proof Ground Fault Outlet Bottom Leg Switched 14 Gauge Wire Only” indicia 310 indicating the type of module 300. A module 300 comprises at least one at least one female receptacle 320 and one female receptacle 322 for switching on or off the electrical power to bottom leg of a device 100. An optional media device 100 comprises USB device female receptacle 324 and eight pin device female receptacle 340. A U-shaped hooking point 328 is part of the front recessed face 321 on a module 300 used for reconnection of a module 300 to a box 200 from the front.

FIG. 13 illustrates a rear face of a module 300 comprises “top” indicia 304 indicating the top of a down-line device 100 and “for example: 15 Amp Tamper Proof Ground Fault Outlet Bottom Leg Switched 14 Gauge Wire Only” indicia 310 indicating the type of module 300. Module 300 comprises “LINE-IN” indicia 330 indicating the wire insertion holes below it receive power-in from and electrical cable. Module 300 comprises “OLD WORK” indicia 338 indicating the wire insertion holes below it are for obtaining power from a device 100 for a future new device 100. Module 300 comprises “LOAD-OUT” indicia 336 indicating the wire insertion holes below it to loop a power cable to another device 100. Wire insertion holes 332 are to connect a black, white, ground wires to a module 300. Module 300 comprises “B, W and G” indicia 334 indicating the color of the wires to be inserted into the wire insertion holes 332 above the indicia.

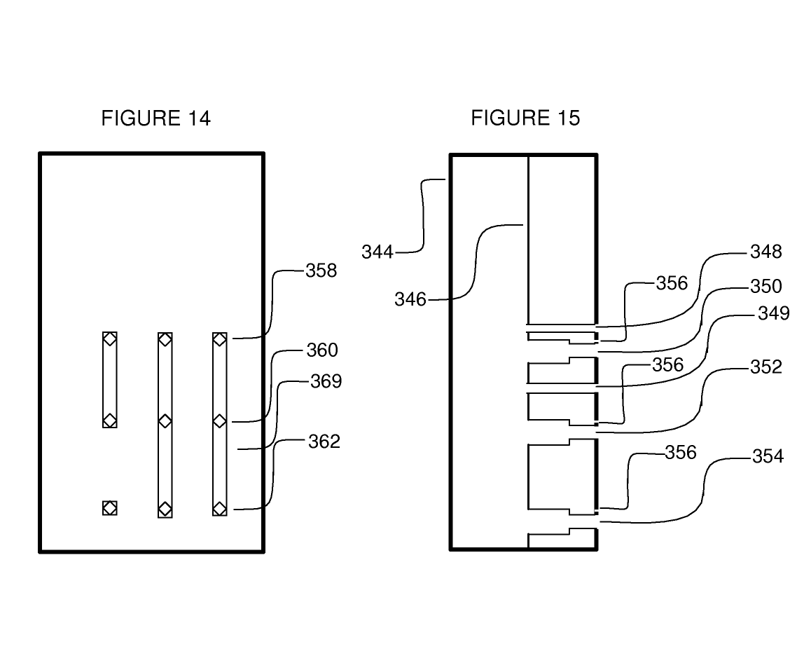

FIG. 14 illustrates an inside view of a module 300. Module 300 comprises wire insertion holes 358, 360 and 362 that may be connected to conductive strips 369.

FIG. 15 illustrates a cross section of a module 300 comprise a recesses front side 346. Module 300 comprises a series of USB wire insertion holes 348, Line-In wire insertion holes 350, 8-Pin wire insertion holes 349, Old Work wire insertion holes 352 and Load-Out 354. Module 300 comprises a release hole 356 for removing an inserted wire.

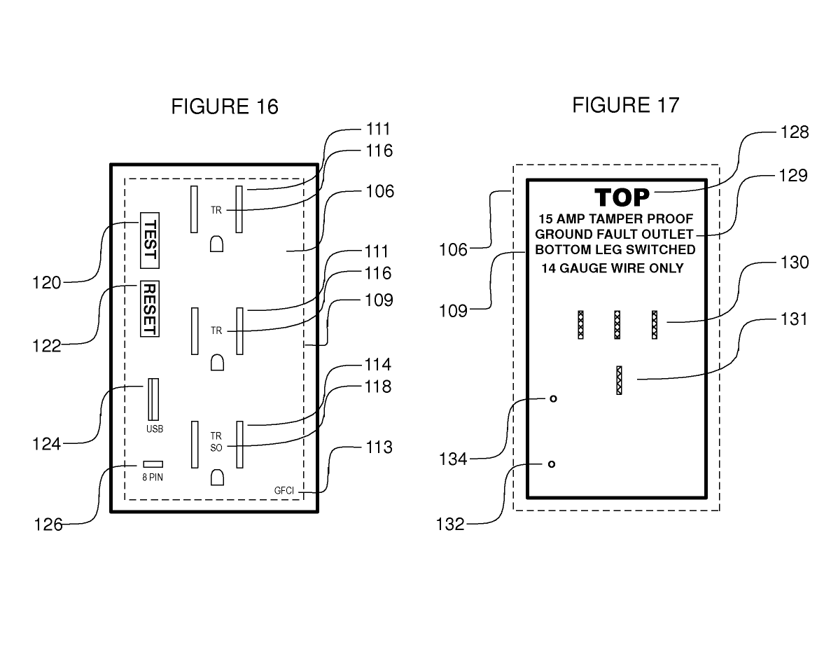

FIG. 16, illustrates the front face of Ground Fault Circuit Interrupter (GFCI) device 100 or an ARC Fault Interrupter Circuit (AFCI) device 100 (not shown) with optional media device 100. Ground Fault Circuit Interrupter (GFCI) device 100 or an ARC Fault Interrupter Circuit (AFCI) device 100 (not shown) comprises a Ground Fault Circuit Interrupter (GFCI) Test Button 120 or an ARC Fault Interrupter Circuit (AFCI) Test button 120 (not shown) and Ground Fault Circuit Interrupter (GFCI) Reset Button 122 or an ARC Fault Interrupter Circuit (AFCI) Reset button 122 (not shown). A device 100 comprises at least one female receptacle 111 and at least one female receptacle 114 comprises indicia TR 116 indicating that the outlet legs are Tamper Proof. The bottom leg comprises indicia “SO” 118 indicating that the bottom leg has built-in make-up to make it a switched outlet. A face plate 106 comprises indicia “AFCI” 113 describing the type of protection, in this case indicating that a device 100 is ARC Fault Interrupter Circuit (AFCI) protected. An optional media device 100 comprises an USB device 124 and an eight pin device 126. Dashed lines 109 depict the side walls 107 of a device 100 behind a face plate 106.

FIG. 17 illustrates the rear face of an ARC Fault Interrupter Circuit (AFCI) device 100 comprises “top” indicia 128 indicating the top of an electrical device 100 and “for example: 15 Amp Tamper Proof Ground Fault Outlet Bottom Leg Switched 14 Gauge Wire Only” indicia 129 indicating the type of device 100. A device 100 comprises at least one male plug 130 to supply electrical current to the device to each of the device's legs and one male plug 131 to switch electrical power to the bottom leg on or off. A device 100 comprises a male USB plug 134 to supply electrical power to the USB device 124 and comprises a male eight pin plug 132 to supply power to the eight pin device 126.

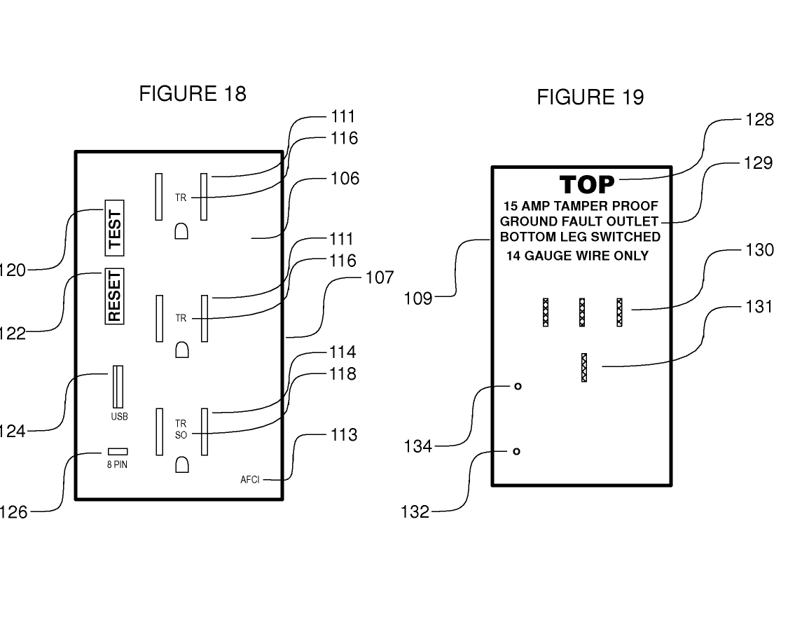

FIG. 18, illustrates the front face of an ARC Fault Interrupter Circuit (AFCI) construction device 100 with an optional media device 100 comprise an ARC Fault Interrupter Circuit (AFCI) Test button 120 and Reset button 122. A construction device 100 comprises at least one female receptacle 111 and at least one female receptacle 114 comprises indicia TR 116 indicating that the outlet legs are Tamper Proof. The bottom leg comprises indicia “SO” 118 indicating that the bottom leg has built-in make-up to make it a switched outlet. A construction device 100 face plate 106 does not extend past the device 100 side walls 107. A face plate 106 comprises indicia ARC Fault Interrupter Circuit (AFCI) 113 describing the type of protection, in this case indicating that the device 100 is ARC Fault Interrupter Circuit (AFCI) protected. An optional media device comprises an USB device 124 and an eight pin device 126.

FIG. 19 illustrates the rear face of an ARC Fault Interrupter Circuit (AFCI) construction device 100 comprises “top” indicia 128 indicating the top of a construction device 100 and “for example: 15 Amp Tamper Proof Ground Fault Outlet Bottom Leg Switched 14 Gauge Wire Only” indicia 129 indicating the type of device 100. A device 100 comprises at least one male plug 130 to supply electrical current to the device to each of the device's legs and one male plug 131 to switch electrical power to the bottom leg on or off. A device 100 comprises a male USB plug 134 to supply electrical power to the USB device 124 and comprises a male eight pin plug 132 to supply power to the eight pin device 126.

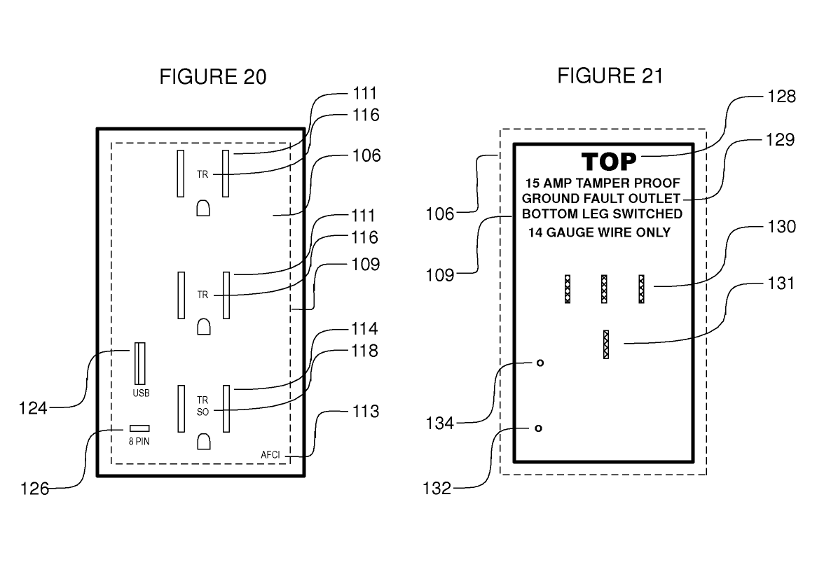

FIG. 20, illustrates the front face of an ARC Fault Interrupter Circuit (AFCI) down-line device 100 with an optional media device 100. A down-line device 100 does not have an ARC Fault Interrupter Circuit (AFCI) device 100 but is has ARC Fault Interrupter Circuit (AFCI) protection from an up-line ARC Fault Interrupter Circuit (AFCI) outlet. A down-line device 100 comprises at least one female receptacle 111 and at least one female receptacle 114 comprises indicia TR 116 indicating that the outlet legs are Tamper Proof. The bottom leg comprises indicia “SO” 118 indicating that the bottom leg has built-in make-up to make it a switched outlet. A face plate 106 comprises indicia ARC Fault Interrupter Circuit (AFCI) 113 describing the type of protection, in this case indicating that a device 100 is ARC Fault Interrupter Circuit (AFCI) protected. An optional media device 100 comprises an USB device 124 and an eight pin device 126. Dashed lines 109 depict the side walls 107 of a device 100 behind a face plate 106.

FIG. 21 illustrates the rear face of an ARC Fault Interrupter Circuit (AFCI) down-line device 100 comprises “top” indicia 128 indicating the top of a down-line device 100 and “for example: 15 Amp Tamper Proof Ground Fault Outlet Bottom Leg Switched 14 Gauge Wire Only” indicia 129 indicating the type of device 100. A down-line device 100 comprises at least one male plug 130 to supply electrical current to the device to each of the device's legs and one male plug 131 to switch electrical power to the bottom leg on or off. A device 100 comprises a male USB plug 134 to supply electrical power to the USB device 124 and comprises a male eight pin plug 132 to supply power to the eight pin device 126.

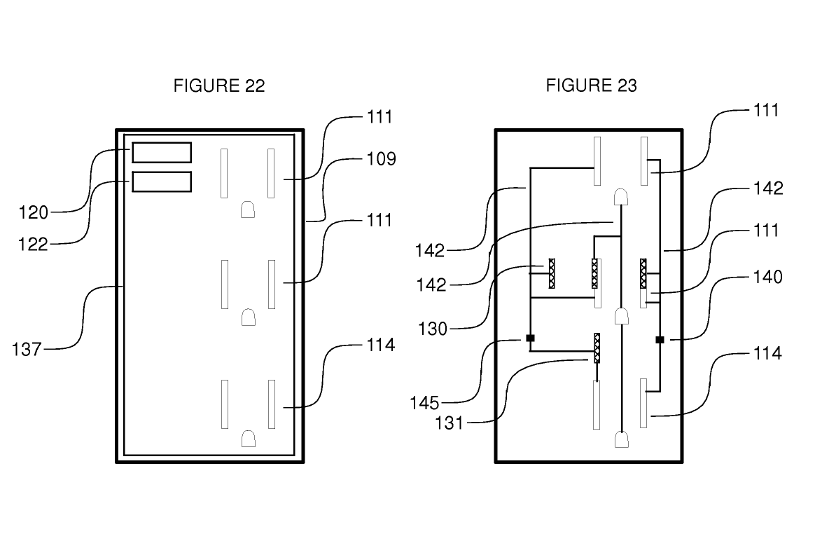

FIG. 22 illustrates the inside of the front face of a Ground Fault Circuit Interrupter (GFCI) or an ARC Fault Interrupter Circuit (AFCI) device 100 (not shown). Female receptacle 111 and female receptacle 114 continue from a face plate 106 for connection to conductive strips. A Ground Fault Circuit Interrupter (GFCI) device 120 or an ARC Fault Interrupter Circuit (AFCI) device 122 (not shown) is inside a device 100. A Ground Fault Circuit Interrupter (GFCI) device or an ARC Fault Interrupter Circuit (AFCI) device (not shown) is embedded inside a device 100. A Ground Fault Circuit Interrupter (GFCI) test device 120 or an ARC Fault Interrupter Circuit (AFCI) test device 122 (not shown) and a Ground Fault Circuit Interrupter (GFCI) reset device 122 or an ARC Fault Interrupter Circuit (AFCI) reset device 122 (not shown) are embedded inside a device 100.

FIG. 23 illustrates the inside of the front face of a Ground Fault Circuit Interrupter (GFCI) device 100 or an ARC Fault Interrupter Circuit (AFCI) device 100 (not shown) with hard-wire make-up. Female receptacle 111 and female receptacle 114 are connected to conductive strips. A conductive strip 142 connects the hot leg of the female receptacles to a Ground Fault Circuit Interrupter (GFCI) contact 145 or an AFCI contact 145 (not shown). A conductive strip 142 connects the neutral leg of the female receptacles to the AFCI contact 140. A conductive strip 142 connects the ground leg of the female receptacles to other ground legs. Male plug 131 is for switching on or off the electrical power to bottom leg of a device 100.

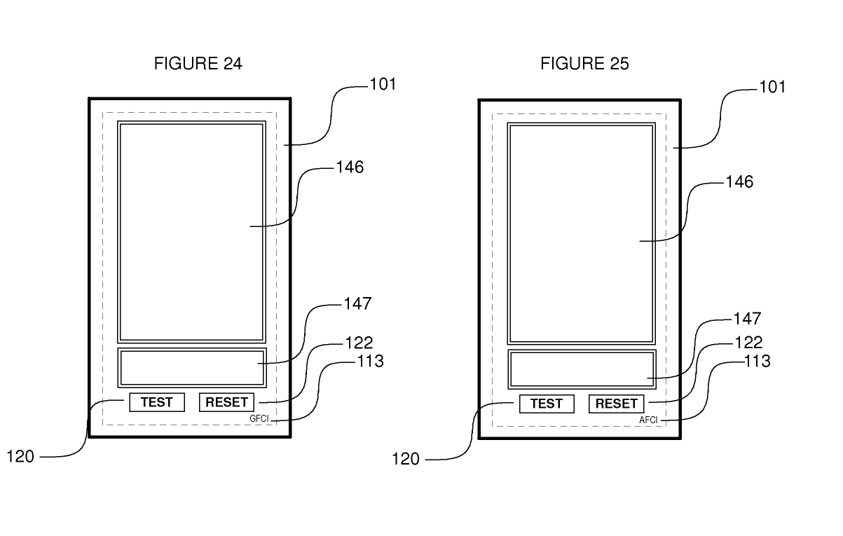

FIG. 24 illustrates a switch device 100 with optional ground fault circuit interrupter fault with switch and Test button 120 and Reset button 122. The switch can be various types; toggle 146, slider (not shown), button (not shown), tap (not shown), dimmer (not shown) or any other type. The top toggle switch 146 is for turning a light fixture on or off. The bottom toggle switch 147 supplies power to a switched outlet (not shown). On the bottom corner of face plate 106 comprises indicia 113 indicating the switch is Ground Fault Circuit Interrupter (GFCI) protected.

FIG. 25 illustrates a single pole switch with optional arc fault circuit interrupter fault with switch and Test button 120 and Reset button 122. The switch can be various types; toggle 146, slider (not shown), button (not shown), tap (not shown), dimmer (not shown) or any other type. The top toggle switch 146 is for turning a light fixture on or off. The bottom toggle switch 147 supplies power to a switched outlet (not shown). On the bottom corner of face plate 106 comprises indicia 154 indicating the switch is ARC Fault Interrupter Circuit (AFCI) protected.

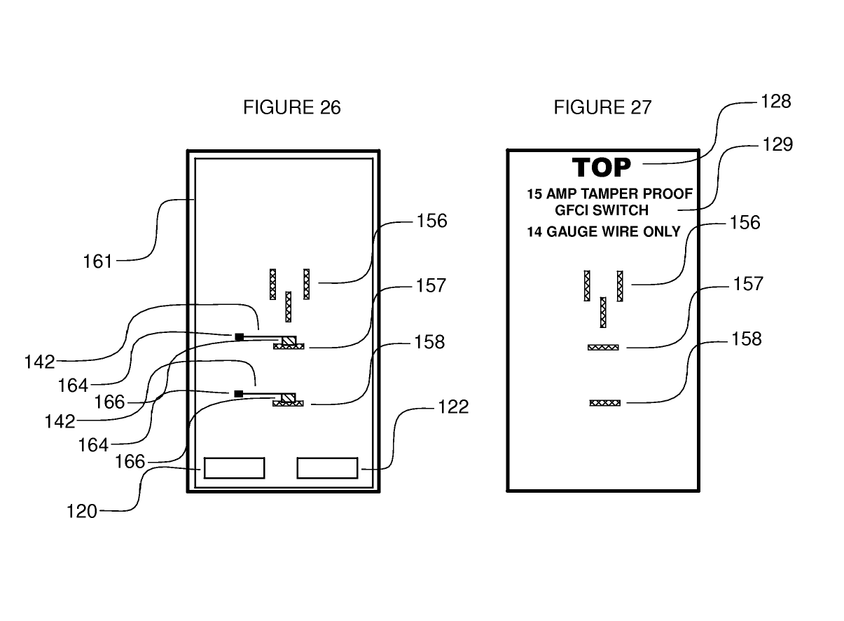

FIG. 26 illustrates the inside of the front face of a Ground Fault Circuit Interrupter (GFCI) device 100 or an ARC Fault Interrupter Circuit (AFCI) device 100 (not shown) depicts the males plugs 156, 157 and 158 inside the device. A Ground Fault Circuit Interrupter (GFCI) device 161 or an ARC Fault Interrupter Circuit (AFCI) device 161 (not shown) is embedded inside a device 100. A Ground Fault Circuit Interrupter (GFCI) test device 120 or an ARC Fault Interrupter Circuit (AFCI) test device 120 (not shown) and a Ground Fault Circuit Interrupter (GFCI) reset device 122 or an ARC Fault Interrupter Circuit (AFCI) reset device 122 (not shown) are part of the a Ground Fault Circuit Interrupter (GFCI) device 161 or an ARC Fault Interrupter Circuit (AFCI) device 161 (not shown). A Ground Fault Circuit Interrupter (GFCI) contact 164 or an Arc Fault Circuit Interrupter (AFCI) contact 164 (not shown) is connected to a conductive strip to connect to the rocker switch to make contact with the male plugs 157 or 158 to create a circuit to supply electrical power to a light outlet (not shown).

FIG. 27 illustrates the rear face of a Ground Fault Circuit Interrupter (GFCI) single pole switch device 100 comprises “top” indicia 128 indicating the top of the switch device 100 and “for example: 15 Amp Tamper Proof Ground Fault Switch 14 Gauge Wire Only” indicia 129 indicating the type of switch device 100. The switch device 100 comprises at least one male plug 156 to supply power into the switch device 100 and at least one male plug 157 to turn on or off power to a light outlet (not shown). The bottom male plug 158 supplies power to a switched outlet to be turned on or off (not shown).

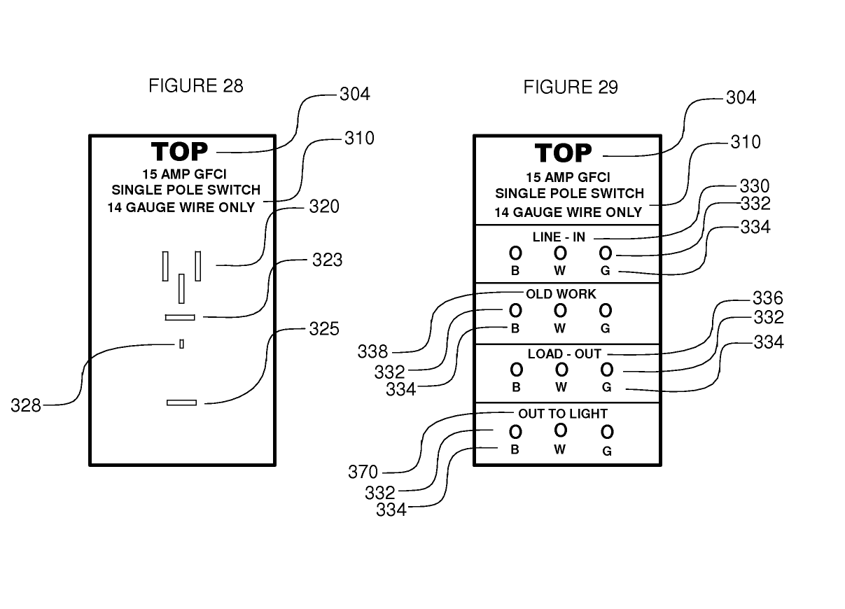

FIG. 28 illustrates the front face of a module 300 comprises “top” indicia 304, indicating the top of a down-line device 100 and “for example: 15 Amp Tamper Proof Ground Fault Switch 14 Gauge Wire Only” indicia 310 indicating the type of module 300. A module 300 comprises at least one at least one female receptacles 320 which supplies power to the device at least on female receptacles 323 supplies power to a light fixture (not shown). A module 300 comprises at least one female receptacle 325 for switching on or off the electrical power to bottom leg of the device 100.

FIG. 29 illustrates a rear face of a module 300 comprises “top” indicia 304 indicating the top of a down-line device 100 and “for example: 15 Amp Tamper Proof Ground Fault Outlet Bottom Leg Switched 14 Gauge Wire Only” indicia 310 indicating the type of module 300. Module 300 comprises “LINE-IN” indicia 330 indicating the wire insertion holes 332 below it receive power-in from and electrical cable. Module 300 comprises “OLD WORK” indicia 338 indicating the wire insertion holes 332 below it are for obtaining power from a device 100 for a future new device 100. Module 300 comprises “LOAD-OUT” indicia 336 indicating the wire insertion holes 332 below it to loop a power cable to another device 100. Module 300 comprises “OUT TO LIGHT” indicia 370 indicating the wire insertion holes 332 below it to loop a power cable to another device 100. Wire insertion holes 332 are to connect a black, white, ground wires to a module 300. Module 300 comprises “B. W and G” indicia 334 indicating the color of the wires to be inserted into the wire insertion holes 332 above the indicia.

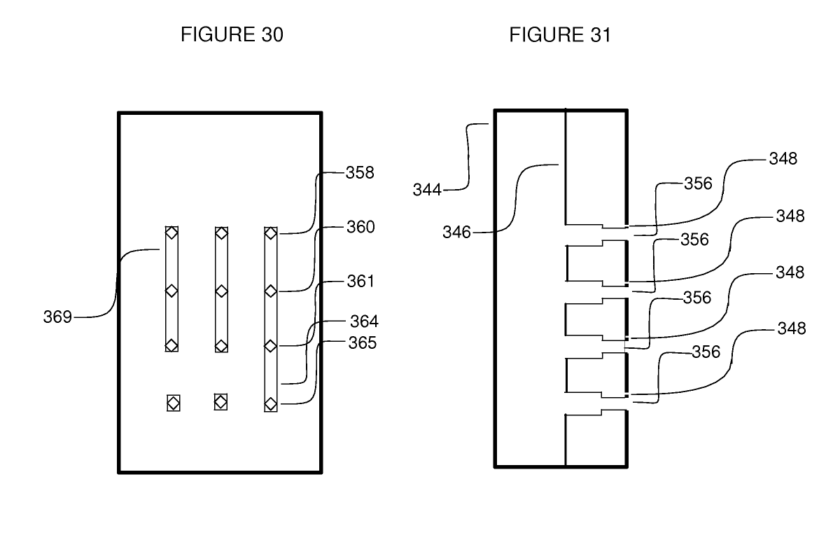

FIG. 30 illustrates an inside view of a module 300. Module 300 comprises wire insertion holes 358, 360, 361, 364 and 365 that may be connected to conductive strips 369.

FIG. 31 illustrates a cross section of a module 300 comprise a recesses front side 346. Module 300 comprises a series of wire insertion holes; Line-In wire insertion holes 350, Old Work wire insertion holes 352 and Load-Out 354. Module 300 comprises a release hole 356 for removing an inserted wire.

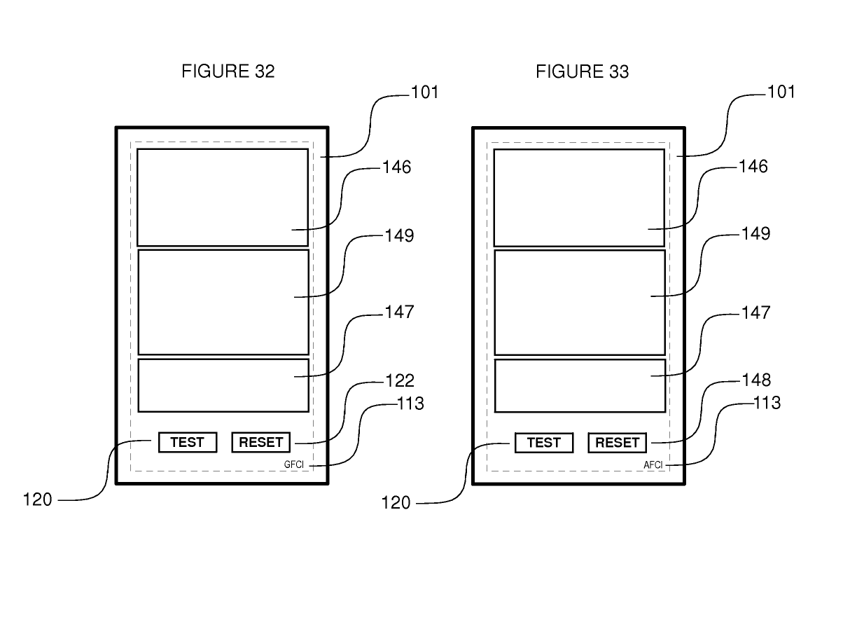

FIG. 32 illustrates a switch device 100 with optional ground fault circuit interrupter fault with switch and Test button 120 and Reset button 122. The switches can be various types; toggle 146, slider (not shown), button (not shown), tap (not shown), dimmer (not shown) or any other type. The top toggle switch 146 is for turning a light fixture on or off. The top toggle switch 149 is for turning a light fixture on or off. The bottom toggle switch 147 supplies power to a switched outlet (not shown). On the bottom corner of face plate 106 comprises indicia 113 indicating the switch is Ground Fault Circuit Interrupter (GFCI) protected.

FIG. 33 illustrates a switch device 100 with optional ground fault circuit interrupter fault with switch and Test button 120 and Reset button 122. The switches can be various types; toggle 146, slider (not shown), button (not shown), tap (not shown), dimmer (not shown) or any other type. The top toggle switch 146 is for turning a light fixture on or off. The top toggle switch 149 is for turning a light fixture on or off. The bottom toggle switch 147 supplies power to a switched outlet (not shown). On the bottom corner of face plate 106 comprises indicia 154 indicating the switch is Arc Fault Interrupter Circuit (GFCI) protected.

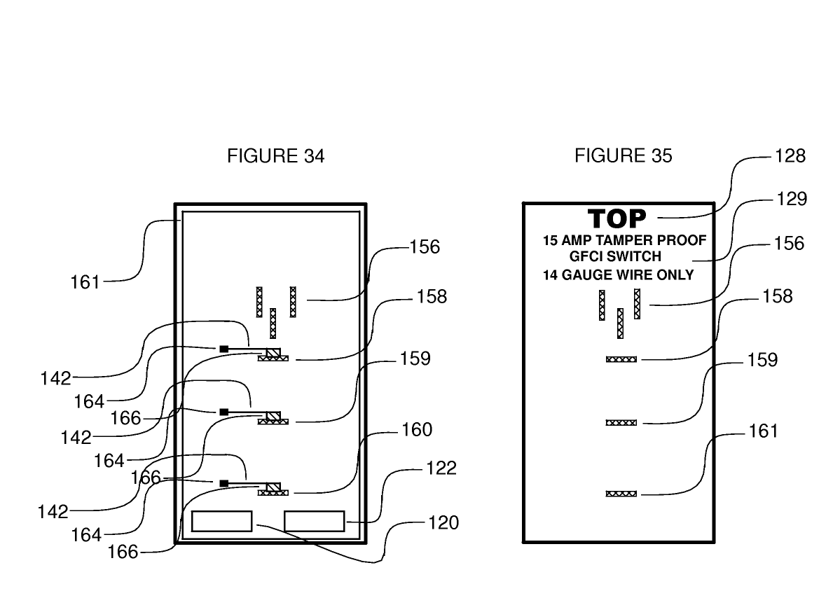

FIG. 34 illustrates the inside of the front face of a Ground Fault Circuit Interrupter (GFCI) device 100 or an ARC Fault Interrupter Circuit (AFCI) device 100 (not shown) depicts the males plugs 156, 157, 158 and 160 inside the device. A Ground Fault Circuit Interrupter (GFCI) device 161 or an ARC Fault Interrupter Circuit (AFCI) device 161 (not shown) is embedded inside a device 100. A Ground Fault Circuit Interrupter (GFCI) test device 120 or an ARC Fault Interrupter Circuit (AFCI) test device 122 (not shown) and a Ground Fault Circuit Interrupter (GFCI) reset device 122 or an ARC Fault Interrupter Circuit (AFCI) reset device 122 (not shown) are part of the a Ground Fault Circuit Interrupter (GFCI) device 161 or an ARC Fault Interrupter Circuit (AFCI) device 161 (not shown). A Ground Fault Circuit Interrupter (GFCI) contact 164 or an Arc Fault Circuit Interrupter (AFCI) contact 164 (not shown) is connected to a conductive strip to connect to the rocker switch to make contact with the male plugs 157 or 158 or 160 to create a circuit to supply electrical power to a light outlet (not shown).

FIG. 35 illustrates the rear face of a Ground Fault Circuit Interrupter (GFCI) single pole switch device 100 comprises “top” indicia 128 indicating the top of the switch device 100 and “for example: 15 Amp Tamper Proof Ground Fault Switch 14 Gauge Wire Only” indicia 129 indicating the type of switch device 100. The switch device 100 comprises at least one male plug 156 for power into the switch device 100 and at least one male plug 157 to turn on or off power to a light outlet (not shown). The bottom male plugs 158, 159 or 160 supplies power to a switched outlet (not shown).

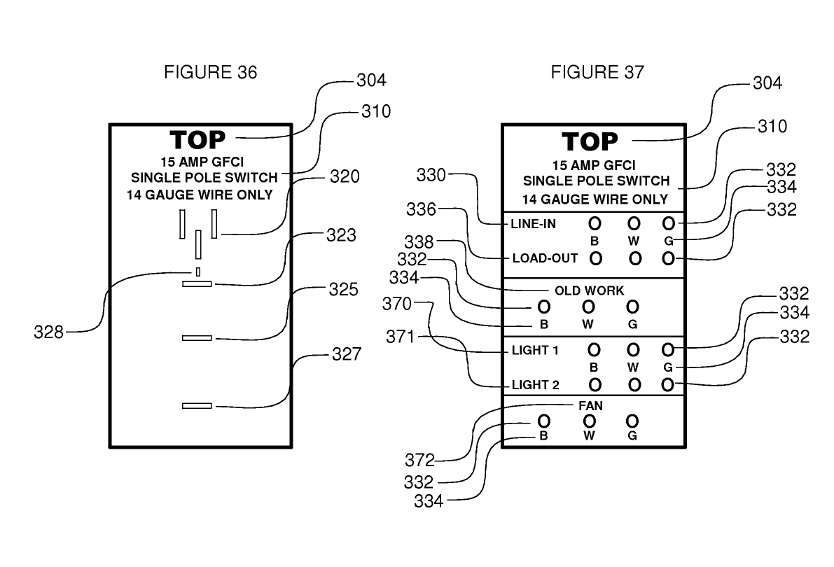

FIG. 36 illustrates the front face of a module 300 comprises “top” indicia 304 indicating the top of a down-line device 100 and “for example: 15 Amp Tamper Proof Ground Fault Switch 14 Gauge Wire Only” indicia 310 indicating the type of module 300. A module 300 comprises at least one at least one female receptacles 320 which supplies power to the device at least on female receptacles 323 supplies power to a light fixture 1 (not shown), at least one female receptacle 325 supplies power to a light fixture 2 (not shown) and 327 supplies power to a fan (not shown).

FIG. 37 illustrates a rear face of a module 300 comprises “top” indicia 304 indicating the top of a down-line device 100 and “for example: 15 Amp Tamper Proof Ground Fault Outlet Bottom Leg Switched 14 Gauge Wire Only” indicia 310 indicating the type of module 300. Module 300 comprises “LINE-IN” indicia 330 indicating the wire insertion holes 332 below it receive power-in from and electrical cable. Module 300 comprises “OLD WORK” indicia 338 indicating the wire insertion holes 332 below it are for obtaining power from a device 100 for a future new device 100. Module 300 comprises “LOAD-OUT” indicia 336 indicating the wire insertion holes 332 below it to loop a power cable to another device 100. Module 300 comprises “LIGHT1” indicia 370 indicating the wire insertion holes 332 below it to loop a power cable to another device 100. Module 300 comprises “LIGHT2” indicia 371 indicating the wire insertion holes 332 below it to loop a power cable to another device 100. Module 300 comprises “Fan” indicia 372 indicating the wire insertion holes 332 below it to loop a power cable to another device 100. Wire insertion holes 332 are to connect a black, white, ground wires to a module 300. Module 300 comprises “B, W and G” indicia 334 indicating the color of the wires to be inserted into the wire insertion holes 332 above the indicia.

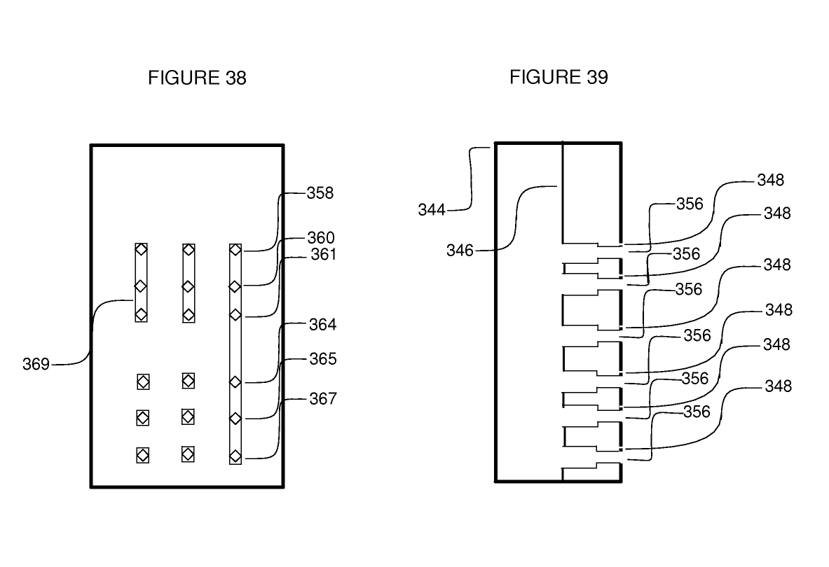

FIG. 38 illustrates an inside view of a module 300. Module 300 comprises wire insertion holes 358, 360, 361, 364, 365 and 367 that may be connected to conductive strips 369.

FIG. 39 illustrates a cross section of a module 300 comprises a recesses front side 346. Module 300 comprises a series of wire insertion holes 356; Line-in, Load-out, Old Work, Light 1. Light 2 and fan. Module 300 comprises a release hole 356 for removing an inserted wire.

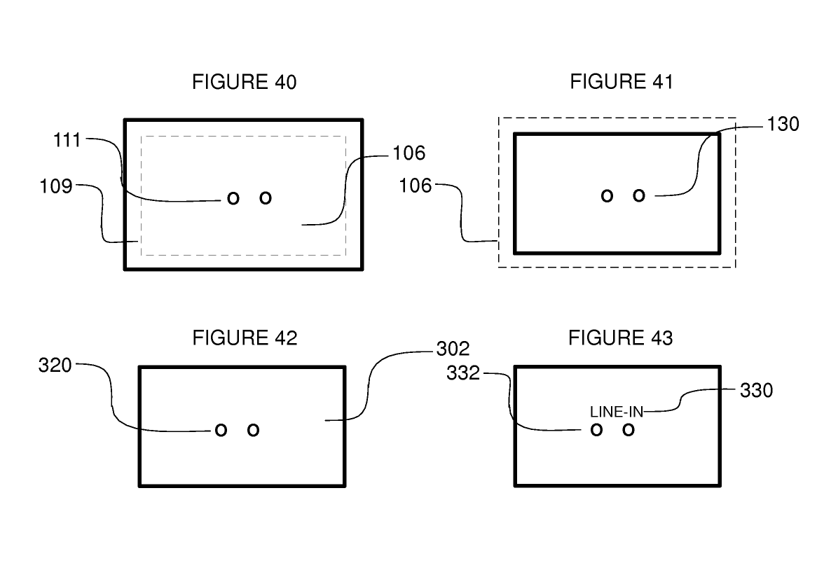

FIG. 40 illustrates the front view of a speaker device 100. Dashed lines depict side walls 109 of the speaker device 100 behind the face plate 106. On the front face of the face plate 106 depicts a pair of outlet female receptacles 111.

FIG. 41 illustrates the rear face of a speaker device 100. Dashed lines 106 depict the face plate behind the speaker device 100. On the rear face of the device 100 depicts a pair or male plugs 130.

FIG. 42 illustrates the recessed front face 302 of the speaker module 300. On the front face of the speaker module 300 depicts a pair or female receptacles 320.

FIG. 43 illustrates the rear face of a speaker module 300. Module 300 comprises “LINE-IN” indicia 330 indicating the wire insertion holes 332 below it receive power-in from and speaker cable.

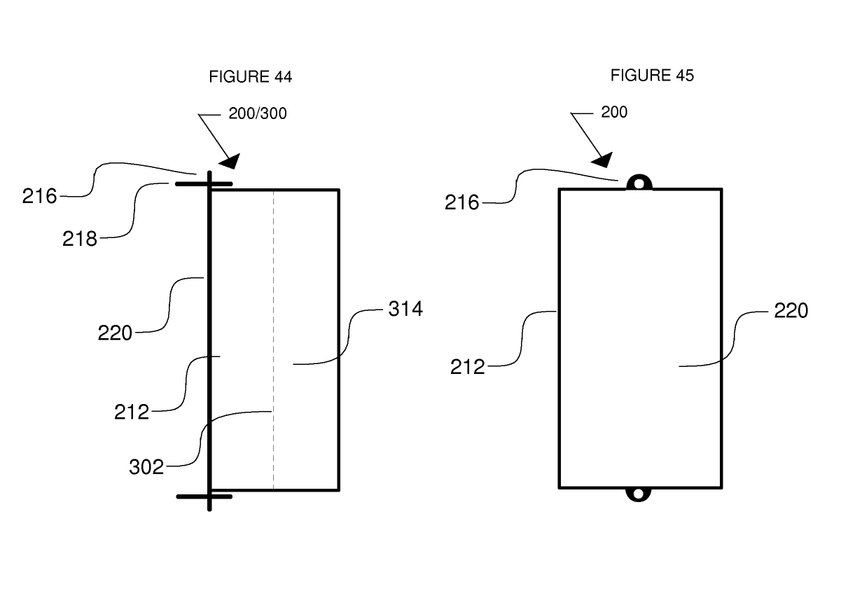

FIG. 44 is another embodiment of the invention and illustrates the retrofit box 200 designed for residential and commercial structures comprises a combination of a box with an open front 220 and a module 300 as the back part of the box/module combo 200/300. The box 200 comprises side walls 212 that have attachment ridges (not shown) on the inside walls. The box 200 comprises screw flares 216 that fit within the screw flares of the existing box (not shown) that use screws 218 to attach inside of an existing box in a wall. The recessed front face 302 of the box/module combo 200/300 has at least one female receptacle (not shown). The side of the module 314 is shown as the back part of the box/module combo 200/300.

FIG. 45 illustrates the front of a box/module 200/300 comprises a screw flare 216 centered on the top and bottom of the box/module 200/300. The front of the box/module 200/300 is open.

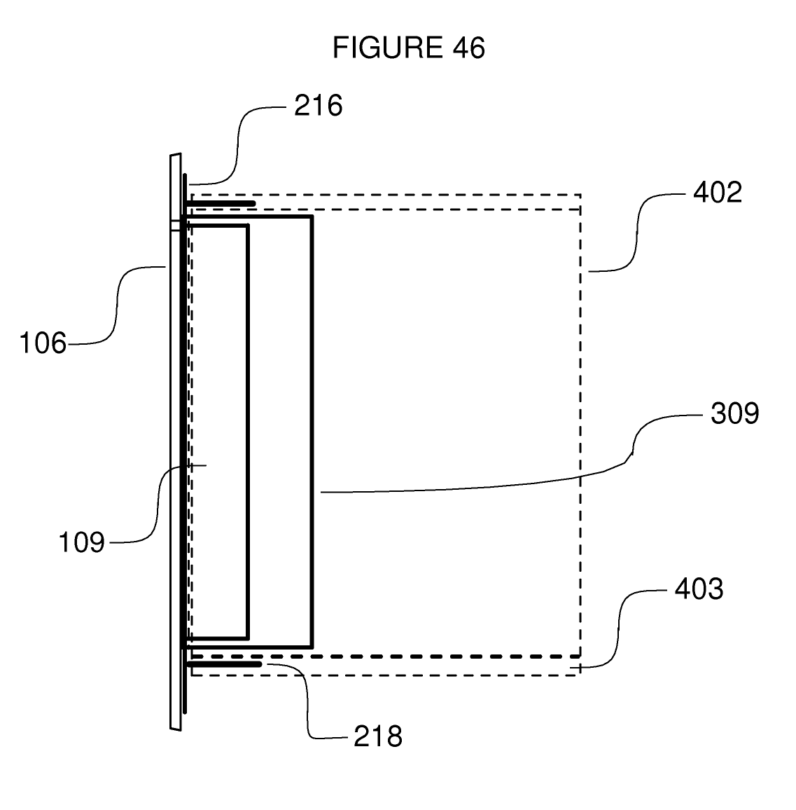

FIG. 46 illustrates the retrofit box/module 200/300 with a device 100 attached and installed inside of an existing box. The box/module 200/300 is installed inside of the existing box 402 by screwing the screws 218 into the existing screw screw-flange 403 of the existing box 402. There is sufficient space between the back of the existing box 402 and the back of the back 309 of the box/module 200/300 for the existing wires to remain in the existing box 402 and to be inserted into the insertion hole (not show). The device 100 depicts a face place 106 and side walls 109 are inserted in the box/module 200/300.

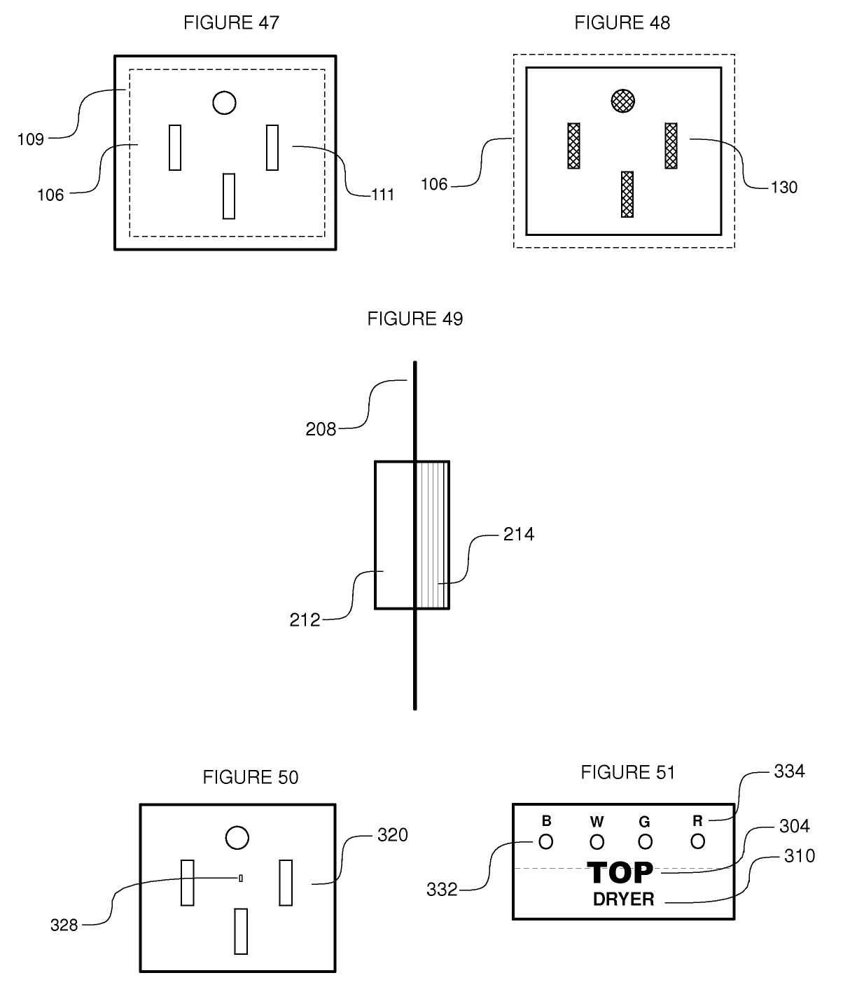

FIG. 47 illustrates the front view of a dryer device 100. Dashed lines depict side walls 109 of the dryer device 100 behind the face plate 106. On the front face of the face plate 106 depicts a pair of outlet female receptacles 111.

FIG. 48 illustrates the rear face of a dryer device 100. Dashed lines 106 depict the face plate behind the dryer device 100. On the rear face of the dryer device 100 depicts a pair or male plugs 130.

FIG. 49 illustrates a box 200 comprise a screw-flange which may also have attachment ridges 214 inside the front half (not show) for attaching with a device 100 and may have attachment ridges 214 on the back of a box 200 are for attaching the module 300.

FIG. 50 illustrates the recessed front face of the dryer module 300. On the front face of the dryer module 300 depicts a pair or female receptacles 320. A U-shaped hooking point 328 is part of the front recessed face 321 on a module 300 used for reconnection of a module 300 to a box 200 from the front.

FIG. 51 illustrates the rear face of a dryer module 300 comprises “top” indicia 304 indicating the top of a dryer device 100 and “DRYER” indicia 310 indicating the type of module 300. Dryer module 300 comprises “B, W and G” indicia 334 indicating the color of the wires to be inserted into the wire insertion holes 332 above the indicia. Wire insertion holes 332 are to connect a black, white, ground wires to a dryer module 300.

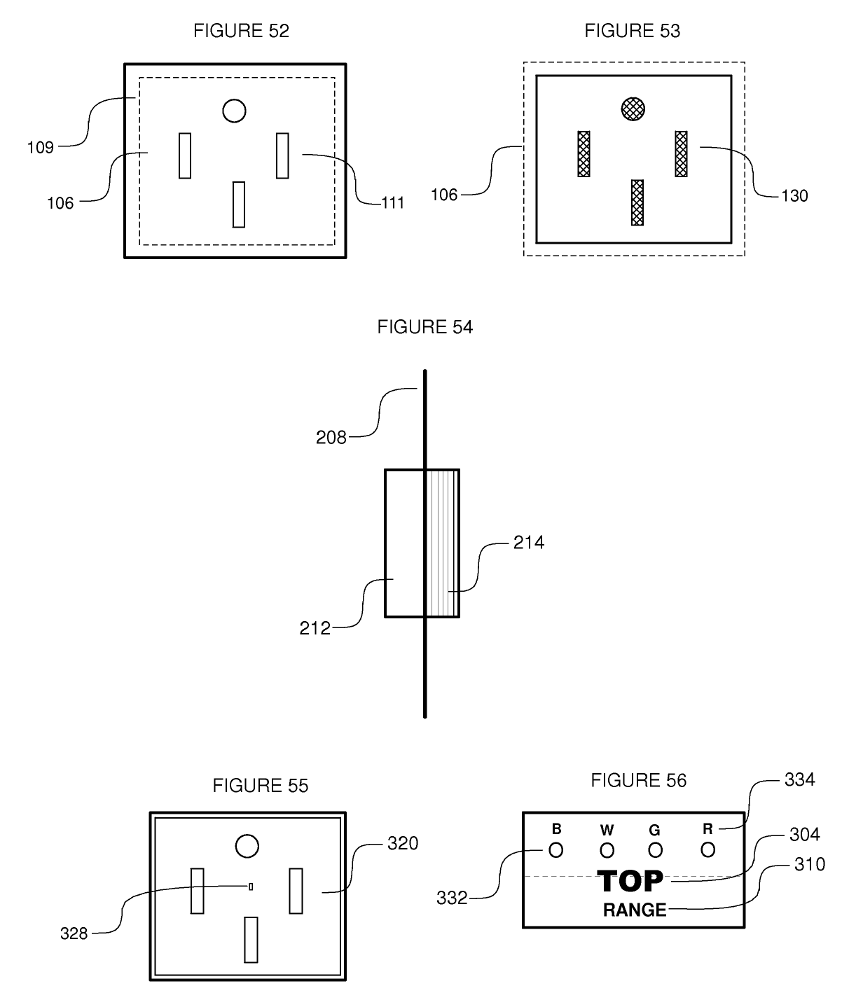

FIG. 52 illustrates the front view of a range device 100. Dashed lines depict side walls 109 of the range device 100 behind the face plate 106. On the front face of the face plate 106 depicts a pair of outlet female receptacles 111.

FIG. 53 illustrates the rear face of a range device 100. Dashed lines 106 depict the face plate behind the range device 100. On the rear face of the device 100 depicts a pair or male plugs 130.

FIG. 54 illustrates a box 200 comprise a screw-flange which may also have attachment ridges 214 inside the front half (not show) for attaching with a device 100 and may have attachment ridges 214 on the back of a box 200 are for attaching the module 300.

FIG. 55 illustrates the recessed front face 302 of the range module 300. On the front face of the range module 300 depicts a pair or female receptacles 320. A U-shaped hooking point 328 is part of the front recessed face 321 on a module 300 used for reconnection of a module 300 to a box 200 from the front.

FIG. 56 illustrates the rear face of a range module 300 comprises “top” indicia 304 indicating the top of a dryer device 100 and “RANGE” indicia 310 indicating the type of module 300. Dryer module 300 comprises “B, W and G” indicia 334 indicating the color of the wires to be inserted into the wire insertion holes 332 above the indicia. Wire insertion holes 332 are to connect a black, white, ground wires to a range module 300.

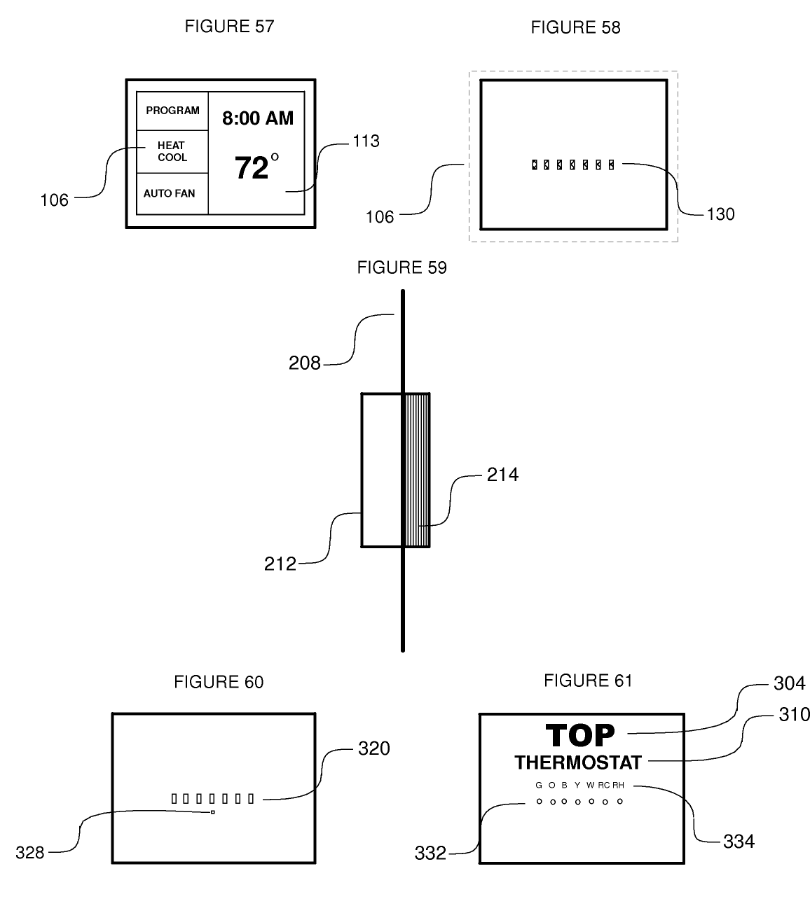

FIG. 57 illustrates the front view of a thermostat device 100. Dashed lines depict side walls 109 of the thermostat device 100 behind the face plate 106. On the front face of the face plate 106 depicts a pair of outlet female receptacles 111.

FIG. 58 illustrates the rear face of a thermostat device 100. Dashed lines 106 depict the face plate behind the thermostat device 100. On the rear face of the device 100 depicts a pair or male plugs 130.

FIG. 59 illustrates a box 200 comprise a screw-flange which may also have attachment ridges 214 inside the front half (not show) for attaching with a device 100 and may have attachment ridges 214 on the back of a box 200 are for attaching the module 300.

FIG. 60 illustrates the recessed front face 302 of the thermostat module 300. On the front face of the thermostat module 300 depicts a pair or female receptacles 320. A U-shaped hooking point 328 is part of the front recessed face 321 on a module 300 used for reconnection of a module 300 to a box 200 from the front.

FIG. 61 illustrates the rear face of a thermostat module 300 comprises “top” indicia 304 indicating the top of a dryer device 100 and “THERMOSTAT” indicia 310 indicating the type of module 300. Thermostat module 300 comprises “B, W and G” indicia 334 indicating the color of the wires to be inserted into the wire insertion holes 332 above the indicia. Wire insertion holes 332 are to connect a black, white, ground wires to a thermostat module 300.

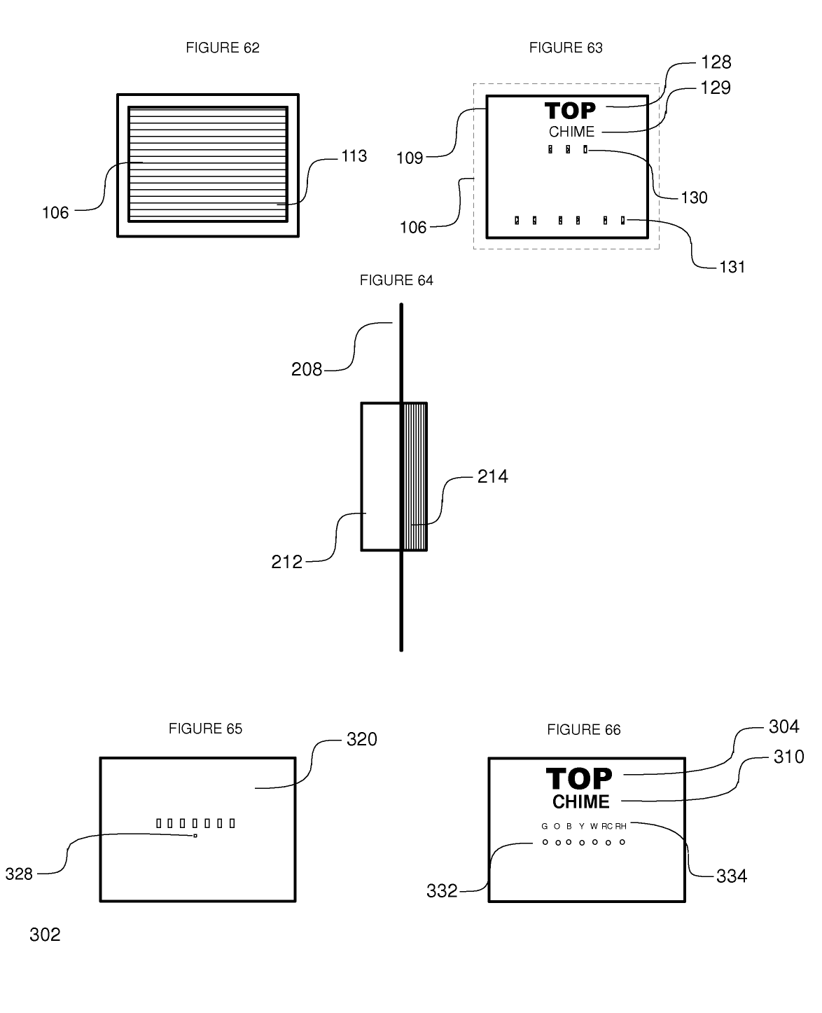

FIG. 62 illustrates the front view of a chime device 100. Dashed lines depict side walls 109 of the chime device 100 behind the face plate 106. On the front face of the face plate 106 depicts a pair of outlet female receptacles 111.

FIG. 63 illustrates the rear face of a chime device 100. Dashed lines 106 depict the face plate behind the chime device 100. On the rear face of the device 100 depicts a pair or male plugs 130.

FIG. 64 illustrates a box 200 comprise a screw-flange which may also have attachment ridges 214 inside the front half (not show) for attaching with a device 100 and may have attachment ridges 214 on the back of a box 200 are for attaching the module 300.

FIG. 65 illustrates the recessed front face 302 of the chime module 300. On the front face of the chime module 300 depicts a pair or female receptacles 320. A U-shaped hooking point 328 is part of the front recessed face 321 on a module 300 used for reconnection of a module 300 to a box 200 from the front.

FIG. 66 illustrates the rear face of a chime module 300 comprises “top” indicia 304 indicating the top of a dryer device 100 and “CHIME” indicia 310 indicating the type of module 300. Chime module 300 comprises “B, W and G” indicia 334 indicating the color of the wires to be inserted into the wire insertion holes 332 above the indicia. Wire insertion holes 332 are to connect a black, white, ground wires to a chime module 300.

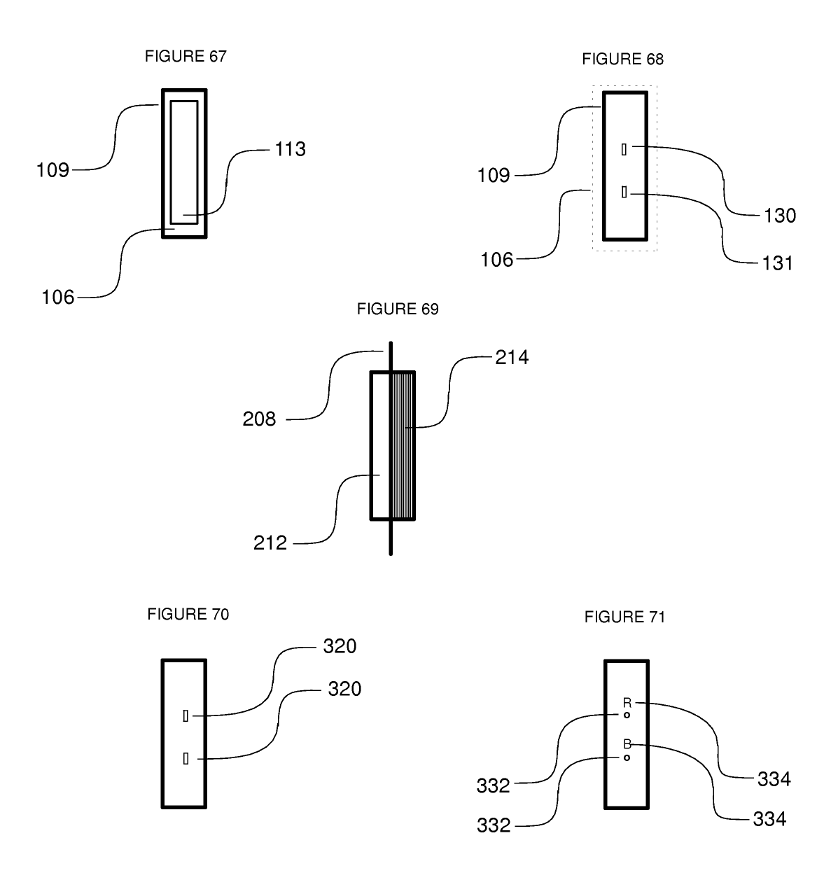

FIG. 67 illustrates the front view of a push button device 100. Dashed lines depict side walls 109 of the push button device 100 behind the face plate 106. On the front face of the face plate 106 depicts a pair of outlet female receptacles 111.

FIG. 68 illustrates the rear face of a push button device 100. Dashed lines 106 depict the face plate behind the push button device 100. On the rear face of the device 100 depicts a pair or male plugs 130.

FIG. 69 illustrates a box 200 comprise a screw-flange which may also have attachment ridges 214 inside the front half (not show) for attaching with a device 100 and may have attachment ridges 214 on the back of a box 200 are for attaching the module 300.

FIG. 70 illustrates the recessed front face 302 of the push button module 300. On the front face of the push button module 300 depicts a pair or female receptacles 320. A U-shaped hooking point 328 is part of the front recessed face 321 on a module 300 used for reconnection of a module 300 to a box 200 from the front.

FIG. 71 illustrates the rear face of a push button module 300 comprises “top” indicia 304 indicating the top of a dryer device 100 and “PUSH BUTTON” indicia 310 indicating the type of module 300. Push button module 300 comprises “B, W and G” indicia 334 indicating the color of the wires to be inserted into the wire insertion holes 332 above the indicia. Wire insertion holes 332 are to connect a black, white, ground wires to a push button module 300.

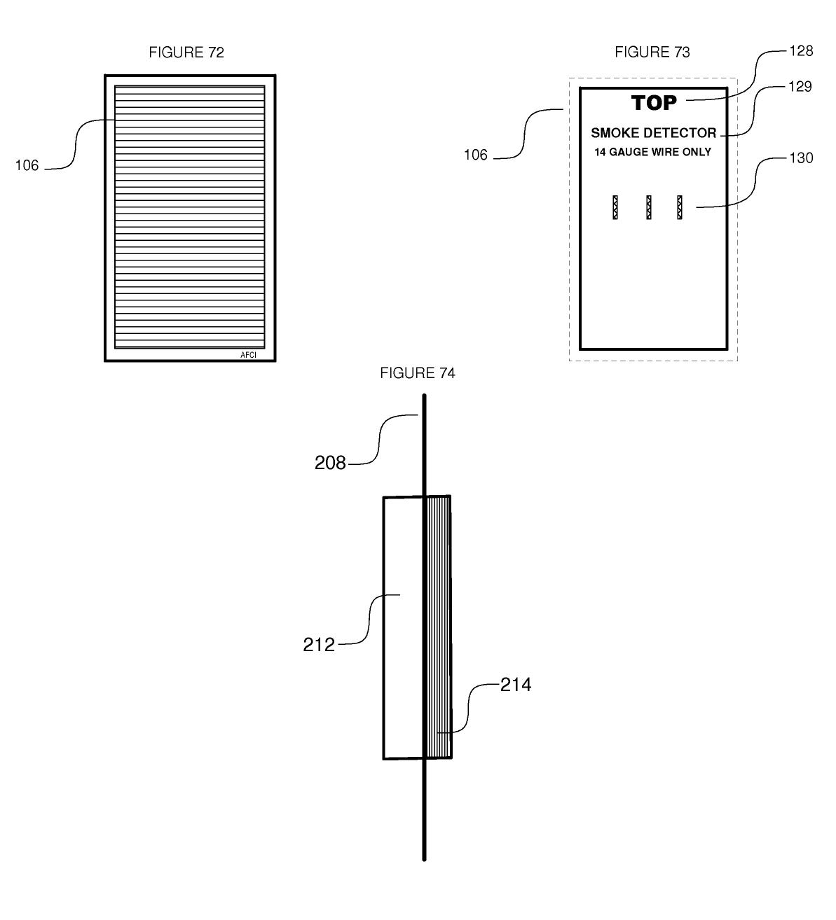

FIG. 72 illustrates the front view of a smoke detector device 100. Dashed lines depict side walls 109 of the smoke detector device 100 behind the face plate 106. On the front face of the face plate 106 depicts a pair of outlet female receptacles 111.

FIG. 73 illustrates the rear face of a smoke detector device 100. Dashed lines 106 depict the face plate behind the smoke detector device 100. On the rear face of the device 100 depicts a pair or male plugs 130.

FIG. 74 illustrates a box 200 comprising a screw-flange which may also have attachment ridges 214 inside the front half (not show) for attaching with a device 100 and may have attachment ridges 214 on the back of a box 200 are for attaching the module 300.

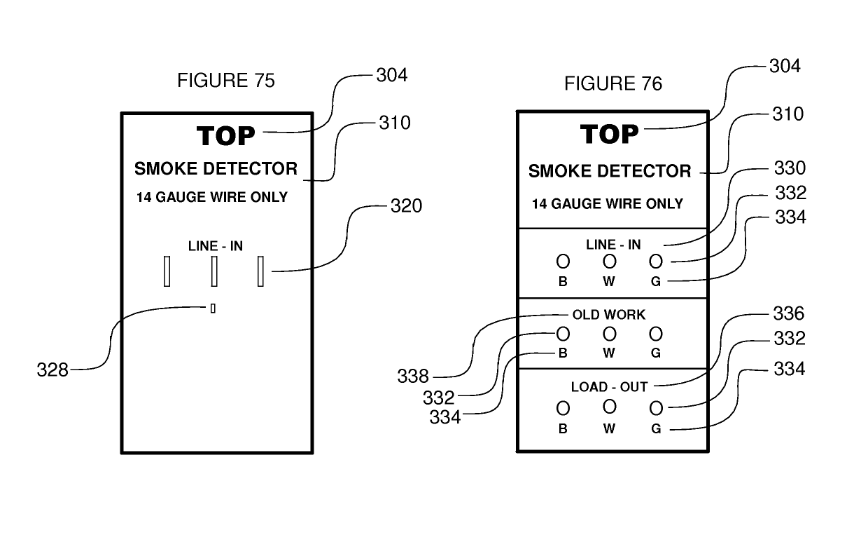

FIG. 75 illustrates the recessed front face 302 of the smoke detector module 300. On the front face of the smoke detector module 300 depicts female receptacles 320. A U-shaped hooking point 328 is part of the front recessed face 321 on a module 300 used for reconnection of a module 300 to a box 200 from the front.

FIG. 76 is another embodiment of the invention and illustrates the rear face of a smoke detector module 300 comprises “top” indicia 304 indicating the top of a dryer device 100 and “SMOKE DETECTOR” indicia 310 indicating the type of module 300. Smoke detector module 300 comprises “LINE-IN” indicia 330 indicating the wire Smoke detector module 300 comprise “B, W and G” indicia 334 indicating the color of the wires to be inserted into the wire insertion holes 332 above the indicia. Wire insertion holes 332 are to connect a black, white, ground wire to a smoke detector module 300 insertion holes 332 below it receive power-in from and electrical cable. Smoke detector module 300 comprises “OLD WORK” indicia 338 indicating the wire insertion holes 332 below it are for obtaining power from a device 100 for a future new device 100. Smoke detector module 300 comprises “LOAD-OUT” indicia 336 indicating the wire insertion holes 332 below it to loop a power cable to another device 100.

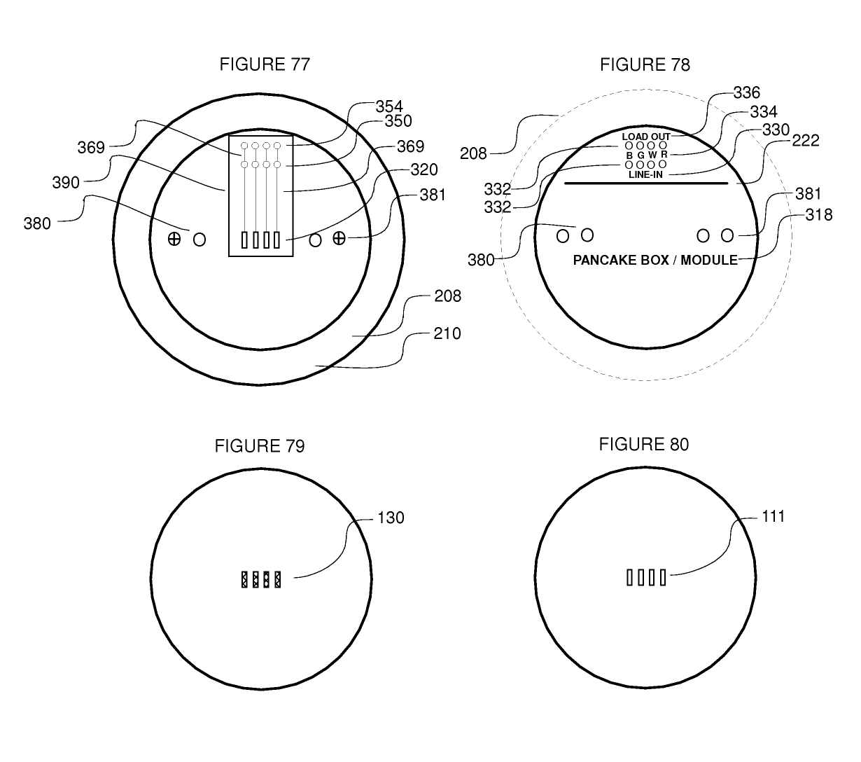

FIG. 77 illustrates the front face light box/module 200/300 comprises circular screw-flange 208 with foam insulation attached to its front face to seal drywall openings. The light box/module 200/300 comprises a module insertion box 390 with female receptacles 320 and the rear insertion holes 354 and 350 with connective strips 369 inside of the module insertion box 390. The front face of the light box/module 200/300 comprise screw holes 381 for attaching light box/module 200/300 to a framing member (not shown) and lag bolt holes 381 for attaching light box/module 200/300 with lag bolts to a framing member 380 for heavier light fixtures and ceiling fans. The light box/module 200/300 comprises attachment ridges 214 to connect with the light device plate 100.

Still referring to FIG. 77, in one exemplary embodiment, the depth of the box/module 200/300 is ½ inch.

FIG. 78 illustrates the rear face light box/module 200/300 comprises circular screw-flange 208 and an alignment arm 222 that is perpendicular to the rear face. On the rear face of the light module 300 depicts screw holes 381 for attaching light box/module 200/300 to a framing member (not shown) and lag holes 380 for attaching light box/module 200/300 with lag bolts to a framing member (not shown) for heavier light fixtures and ceiling fans. The rear face light box/module 200/300 comprises “PANCAKE BOX/MODULE” indicia 318 indicating the type of module 300. Light box/module 200/300 module 300 comprises “B, W and G” indicia 334 indicating the color of the wires to be inserted into the wire insertion holes 332 above the indicia. Wire insertion holes 332 are to connect a black, white, ground wires to a smoke detector module 300. Light box/module 200/300 module 300 comprises “LINE-IN” indicia 330 indicating the wire insertion holes 332 below it receive power-in from and electrical cable. Light box/module 200/300 module 300 comprises “LOAD-OUT” indicia 336 indicating the wire insertion holes 332 below it to loop a power cable to another device 100.

FIG. 79 illustrates the front face of a light box device plate 100 comprises at least one male plug 130 to supply electrical current to the device to each of the device's legs.

FIG. 80 illustrates the rear face of a light box device plate 100 comprises at least one female receptacle 111 to supply electrical current to the light fixture.

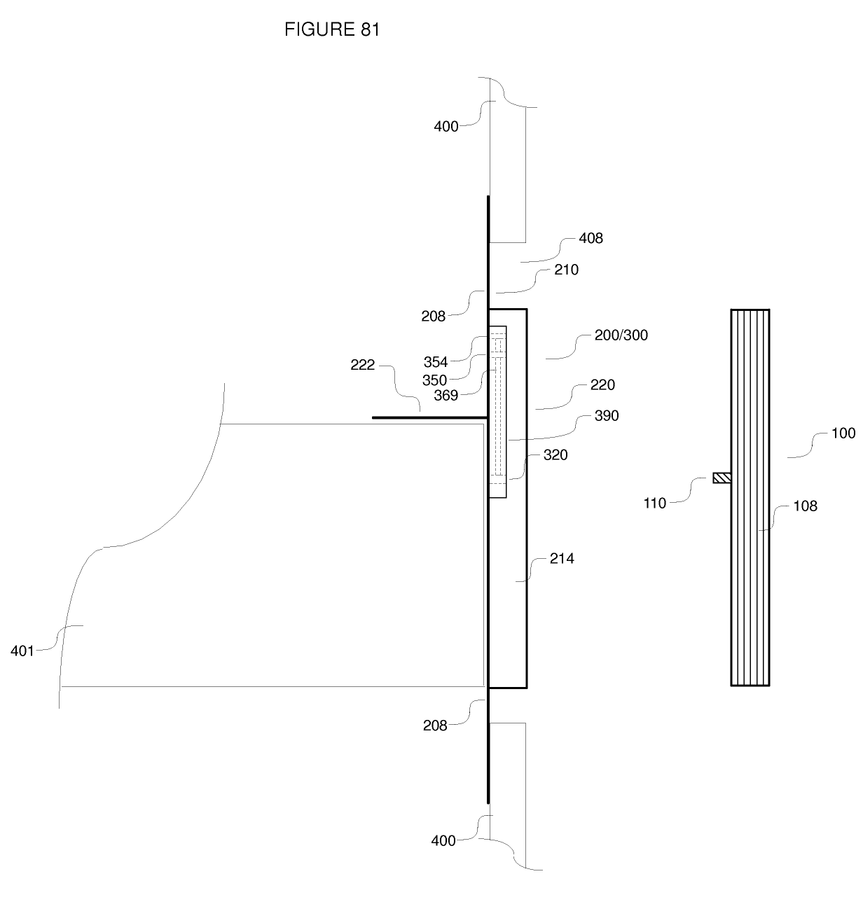

FIG. 81 illustrates a cross section of a light box/module 200/300 and the light device plate 100. The light device plate 100 comprises attachment ridges 108 and at least one male plug 110. The light box/module 200/300 comprises a screw-flange 208 with foam insulation 210 attached to its front face to seal drywall openings and an alignment arm 222 that is perpendicular to the rear face and is 1½ from below the module insertion box 390 to properly align the light box/module 200/300 to a framing member 401. The light box/module 200/300 is attached to the front face of a framing member 401 and behind the drywall 400. Typically the drywall 400 will have an opening 408 between the box and the drywall. This space is sealed with foam insulation 210 attached to its front face of the screw-flange 208 to seal drywall openings. The light box/module 200/300 comprises an open face 220 with attachment ridges 214 on the inside of the light box/module 200/300. The light box/module 200/300 comprises a module insertion box 390 with female receptacles 320 and the rear insertion holes 354 and 350 with connective strips 369 inside of the module insertion box 390.

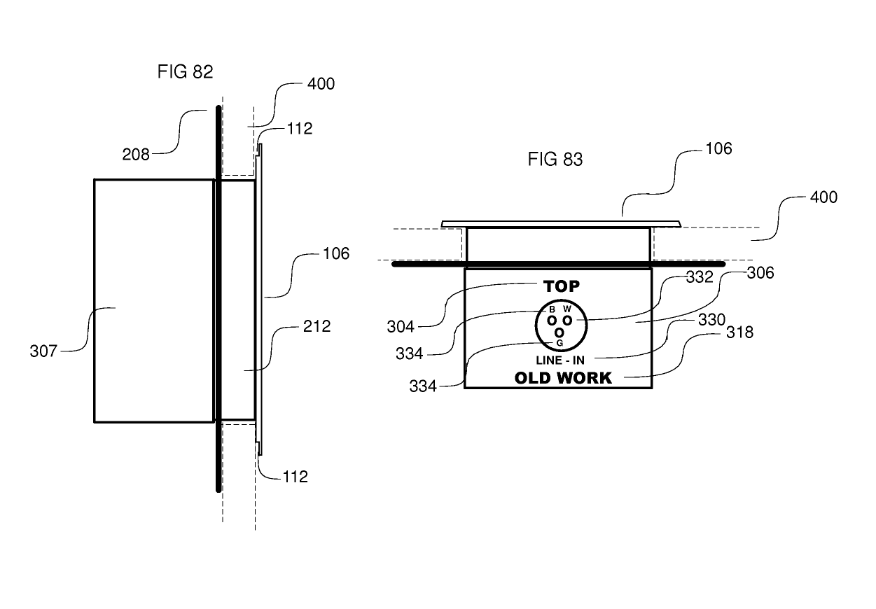

FIG. 82 illustrates a device 100, a box 200 and a commercial module 300 joined together shown with drywall 400 between the faceplate 106 and the screw-flange 208. The side 310 of the commercial module 300 is double that of module 300 to accommodate conduit holes (not shown) and the cables inserted into the commercial module 300 from the conduit (not shown).

FIG. 83 illustrates a top view of a device 100, a box 200 and a commercial module 300 joined together shown with drywall 400 between the device 100 and the screw-flange 208 of the box 200. The top of the commercial module 300 comprises “top” indicia 304 indicating the top of commercial module 300 and “OLD WORK” indicia 338 indicating the wire insertion holes 332 below it are for obtaining power from a device 100 for a future new device 100. The top of the commercial module 300 comprises insertion holes 332 are to connect a black, white, and ground wires to the commercial module 300 and “B, W and G” indicia 334 indicating the color of the wires to be. “LINE-IN” indicia 330 indicate the wire insertion holes 332 below it receive power-in from and electrical cable. The commercial module 300 comprises a conduit connection clip (not shown).

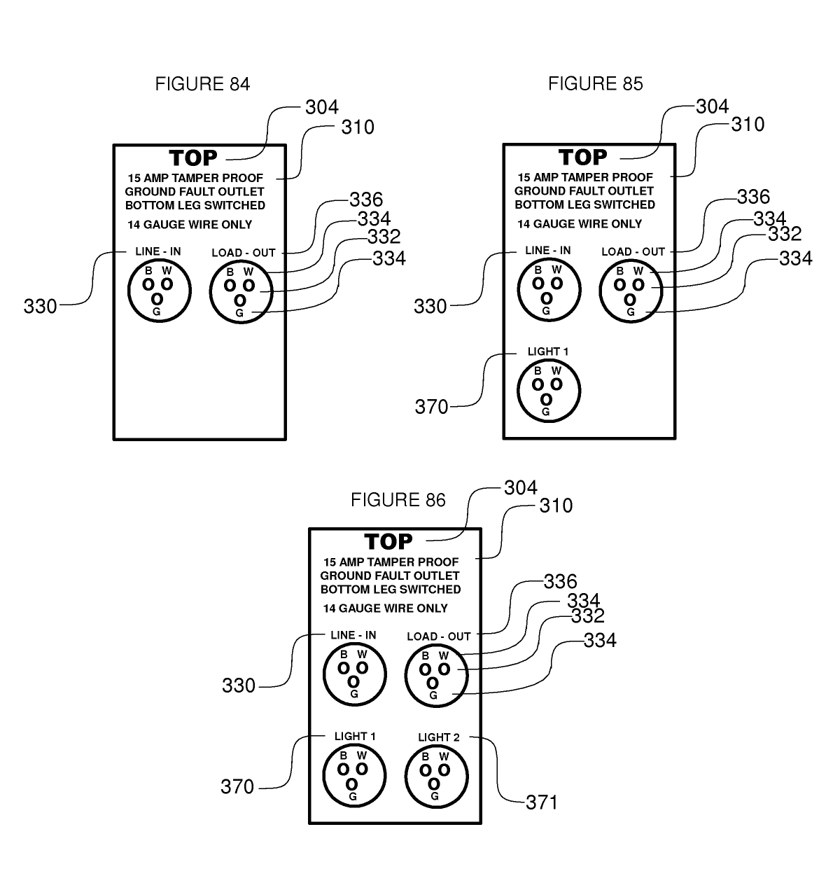

FIG. 84 illustrates a rear face of a commercial module 300 comprises “top” indicia 304 indicating the top of a down-line device 100 and “for example: 15 Amp Tamper Proof Ground Fault Outlet Bottom Leg Switched 14 Gauge Wire Only” indicia 318 indicating the type of a commercial module 300. The commercial module 300 comprises “LINE-N” indicia 330 indicating the wire insertion holes 332 below it receive power-in from and electrical cable. The commercial module 300 comprises “LOAD-OUT” indicia 336 indicating the wire insertion holes 332 below it to loop a power cable to another device 100. The commercial module 300 comprises a conduit connection clip (not shown). The side of the commercial module may have additional wire insertion holes 332.

FIG. 85 illustrates a rear face of a commercial module 300 comprises “top” indicia 304 indicating the top of a down-line device 100) and “for example: 15 Amp Tamper Proof Ground Fault Outlet Bottom Leg Switched 14 Gauge Wire Only” indicia 318 indicating the type of a commercial module 300. The commercial module 300 comprises “LINE-IN” indicia 330 indicating the wire insertion holes 332 below it receive power-in from and electrical cable. The commercial module 300 comprises “LOAD-OUT” indicia 336 indicating the wire insertion holes 332 below it to loop a power cable to another device 100. The commercial module 300 comprises “LIGHT1” indicia 370 indicating the wire insertion holes 332 below it to loop a power cable to another device 100. The commercial module 300 comprises a conduit connection clip (not shown). The side of the commercial module may have additional wire insertion holes 332.

FIG. 86 illustrates a rear face of a commercial module 300 comprises “top” indicia 304 indicating the top of a down-line device 100 and “for example: 15 Amp Tamper Proof Ground Fault Outlet Bottom Leg Switched 14 Gauge Wire Only” indicia 318 indicating the type of a commercial module 300. The commercial module 300 comprises “LINE-IN” indicia 330 indicating the wire insertion holes 332 below it receive power-in from and electrical cable. The commercial module 300 comprises “LOAD-OUT” indicia 336 indicating the wire insertion holes 332 below it to loop a power cable to another device 100. The commercial module 300 comprises “LIGHT1” indicia 370 indicating the wire insertion holes 332 below it to loop a power cable to another device 100. The commercial module 300 comprises “LIGHT2” indicia 371 indicating the wire insertion holes 332 below it to loop a power cable to another device 100. The commercial module 300 comprises a conduit connection clip (not shown). The side of the commercial module may have additional wire insertion holes 332.

What is claimed is:

1. A wiring system having an electrical device, comprising:
a box with two open sides, and a module, wherein the back side of the electrical device comprises at least one male plug and the front side of the module comprises at least one female outlet receptacle;
wherein the at least one male plug inserts into the at least one female outlet receptacle through the open sides of the box when the electrical device is joined with the module through one side of the box and the module is joined to electrical device through the other side of the box;
wherein the module comprises at least one section comprising at least two stab holes, and wherein at least one female outlet receptacle is continuous with at least one stab hole;
wherein the module and the device comprises individualized make-up, circuitry, breakers, coils, sensors or additional wire which executes the function of make-up thus creating the electrical paths to operate different devices dedicated for a predetermined purpose such as an arc fault circuit interrupter outlet, a ground fault circuit interrupter outlet, a single pole switch, a 3-way switch, a 4-way switch, a switched outlet, and a fan switch thus eliminating manual make-up.

2. The wiring system of claim 1, wherein the electrical device is an outlet, a switch, a lighting fixture, a ceiling fan, a smoke detector, a thermostat, a chime, or a push button.

3. The wiring system of claim 1, wherein the box comprises a screw-flange, known in the art, intersecting the box, with holes for attaching the box to another object, wherein the screw-flange, known in the art, is located in the center or in the back of the box, and wherein if the screw-flange, known in the art, is located in the center or the back of the box the holes attach the box to a stud or ceiling rafter.

4. The wiring system of claim 3, wherein the box comprises attachment ridges for attaching the module and/or the device to the box.

5. The wiring system of claim 3, wherein, in the cases in which the screw-flange, known in the art, is located in the front of the box or in the center, the module inserts over the back portion of the box not occupied by the screw-flange, known in the art.

6. The wiring system of claim 1, wherein the electrical device comprises a face plate permanently attached to the front side.

7. The wiring system of claim 1, wherein the electrical device has a permanently attached cover plate comprising switches, outlets, thermostat, chime, push button, smoke detector, switches and outlets.

8. The wiring system of claim 3, wherein the screw-flange, known in the art, comprises foam insulation attached to its front face to seal drywall openings.

9. The wiring system of claim 1, wherein the front side of the module is hollow, ending with a back wall on the front side of the module comprising the at least one female outlet receptacle.

10. The wiring system of claim 1, wherein the stab holes comprises a copper or any conductive material push-in retainer, as known in the art, and consists of a Line-in, Load-in, Old Work, Light1, Light 2, and Fan opening that is either large enough to receive only a #14 gauge wire for a 15 amp circuit, large enough to receive only a #12 gauge wire for a 20 amp circuit or any other size wire and circuit.

11. The wiring system of claim 10, wherein one of the at least two stab holes with a copper or any conductive material push-in retainer, as known in the art, is used for stabbing wires into to supply electrical power and looping wire to another outlet, switch, or light fixture and is large enough to receive only a #14 gauge wire for a 15 amp circuit and large enough to receive only a #12 gauge wire for a 20 amp circuit.

12. The wiring system of claim 1, wherein the module and the electrical devices are color coded with colors that correspond various modules with various electrical devices, the colors coding being based on the type of module and electrical device, including a 15 amp ARC fault outlet, a 20 amp ARC fault outlet, a 15 amp GFCI outlet, a 20 amp GF1 outlet, a 15 amp switch, a 20 amp switch, a 15 amp 3-way switch, a 20 amp 3-way switch, a 15 amp 4-way switch, or a 20 amp 4-way switch, a 15 amp outlet switch, a 20 amp outlet switch, a 15 amp switched outlet, a 20 amp switched outlet, range outlet, dryer outlet, hot water heater outlet, light outlet or any other device.

13. The wiring system of claim 1, wherein the at least one female outlet receptacle of the module is positioned to accommodate the at least one male plug of the electrical device in a corresponding position.

14. The wiring system of claim 1, wherein the at least one stab hole accommodate a black wire, a white wire, a ground wire, or a red wire.

15. The wiring system of claim 1, wherein the module is an outlet module whose back side comprises stab holes comprising two to five sections, namely, a Line-in section, a Load-out section, and an Old Work section, or an optional Multi Media section each section comprising stab holes for a black wire, a white wire, and a ground wire, or red wire.

16. The wiring system of claim 1, wherein the module is a switch module whose back side comprises stab holes comprising two to five sections, namely, a Line-in section, Load Out, an Old Work section, a Out to Light 1 section, a Out to Light 2 section, Out to Fan or a Switched to Outlets section, each section comprising stab holes for a black wire, a white wire, a ground wire or red wire.

17. A wiring system for commercial use comprising: an electrical device, a box with an open front and rear sides comprises conduit connection holes in the conduit connection box, and the module comprises stab holes to receive wires, wherein the back side of the electrical device comprises at least one male plug that inserts into the front side of the module comprising at least one female outlet receptacle;
wherein the conduit connection box houses the module;
wherein the back and top sides of the module comprises at least two stab holes;
wherein the at least one female outlet receptacle of the module is continuous with at least one of the at least two stab holes of the module; and
wherein the module comprises two to five sections of stab holes comprising three to four stab holes in each section and comprises circuitry, breakers, coils, sensors or additional wire which executes the function of make-up thus creating the electrical paths to operate different devices dedicated for a predetermined purpose.

18. The wiring system of claim 17, wherein the electrical device comprises an outlet, a switch, a lighting fixture connection device, a ceiling fan, a thermostat, a chime, a smoke detector, or a push button.

19. The wiring system of claim 17, adapted for swapping out the module and or the device by allowing the box that is attached to framing material behind the drywall to be left in place when changing out the module and or the device.
